(19) United States
(12) Patent Application Publication
(10) Pub. No.: US 2003/0214582 A1
(43) Pub. Date: Nov. 20, 2003

(54) Video delivery apparatus and video information delivery system

(76) Inventors: Kazunori Takahashi, Hitachi (JP); Takeshi Shima, Hitachi (JP)

Correspondence Address: DICKSTEIN SHAPIRO MORIN & OSHINSKY LLP, 2101 L STREET NW, WASHINGTON, DC, 20037-1526, US

(21) Appl. No.: 10/263,057

(22) Filed: Oct. 3, 2002

(30) Foreign Application Priority Data
May 8, 2002 (JP) 2002-132407

(51) Int. Cl. H04N 7/00; H04N 9/47

(52) U.S. Cl. 348/116; 348/148

(57) ABSTRACT

A video delivery apparatus used by the user includes a roadmap selecting means, a link video selecting means, a route video selecting means, a communication speed setting means, a route tool, and a video tool. The user sets a route on a roadmap using the route tool. The video delivery apparatus selects video information corresponding to the route through the link video selecting means and replays the video by displaying images which are extracted so that the replayed image moves at the same speed as the moving speed set by the video tool, not depending on the condition under which the vide has been recorded.

### BACKGROUND OF THE INVENTION

The present invention relates to a video delivery apparatus and a video information delivery system that use road images and its road information.

One example of a road video-used system is a map guidance video system reported in the Dec. 14, 2001, issue of the Mainichi. In this system, images along roads are recorded as video in advance from the inside of a vehicle which is actually driven along the roads and the recorded video is stored in a storage device as video information divided by each intersection of roads. Via a browser, the user displays the Internet Web page and uses a pointing device to enter a request to a map drawn on the Web page in order to reproduce video information as video images on the same Web page from the storage device.

The user makes a request by one of two methods. One method displays the videos recorded along the shortest route between two points (shortest route search method) while the other method urges the user to select a direction at each intersection and displays the video recorded along the selected road (free selection method). In the shortest route search method, the user selects an origin intersection and a destination intersection by using the pointing device. The system searches the map and displays the detected shortest route in a Web page screen. This Web page screen has an area to accept the user's request concerning the video play mode, allowing the user to select normal play, reverse play or pause and change the playing speed. In the free selection method, if an intersection is specified by the user, arrows are displayed in the directions of the roads coming out of the intersection. In response to selection of one arrow by the user, the video for the selected road is replayed until the next intersection where selection of a video is done again likewise through directional specification. In either method, while a video is being replayed, the current position is indicated by a marker moving on the map so that the user can understand the positional consistency of the video with the map. Details of this system are disclosed on the Web page.

On the other hand, “ANTERIOR IMAGE PROCESSOR FOR VEHICLE AND ITS SYSTEM” is disclosed in Japanese Patent Laid-Open No. 205782/1999. In this system, a camera is mounted on a vehicle so as to pick up the scene in front of the vehicle and the action of the driver. The captured image is transmitted to a base station by using radio transmission means. At the base station, the operator checks the image received together with information about the gearshift, the winkers, etc. and gives driving advice by voice.

In the case of the former prior art mentioned above, the road map from which the user selects a road is constituted only by the roads along which video was recorded in advance. To add video information recorded for another road not included in the map, it is therefore necessary to remake the map anew.

In addition, the moving speed of the reproduced road scene depends on the speed at which the image recording vehicle was running while recording the road scene. If the vehicle encountered a traffic congestion or delay by traffic signals, the reproduced image does not move enough fast. Although this prior art is provided with a function to raise the play speed, the user is required to choose from normal play and fast-forward while watching the reproduced image.

On the other hand, the system disclosed in Japanese Patent Laid Open No. 205782/1999 “ANTERIOR IMAGE PROCESSOR FOR VEHICLE AND ITS SYSTEM” is aimed at giving advice to drivers while they are driving. To provide effective advice, however, the operator must have enough knowledge about the pertinent roads.

### SUMMARY OF THE INVENTION

It is an object of the present invention to provide a versatile video delivery apparatus capable of giving support from the stage of preparing video information so that recorded video information can be associated flexibly with a road map.

Another object of the present invention is to provide a video delivery apparatus capable of reproducing an image stream in a way needed by the user not depending on the speed at which the image recording vehicle was running while recording the image stream.

Still another object of the present invention is to provide a system capable of combining the current image stream seen from the user's vehicle with the preliminarily recorded corresponding image stream and indicating them to the user together with necessary information.

To achieve the objects mentioned above, roads are divided by each intersection into road segments and each road segment is further classified by direction into two road elements (hereinafter denoted as links) when they are stored in road map management means as road map information. Video information is recorded together with time information and positional information each of which is determined by separate means. To each recorded video information unit (hereinafter denoted as a frame), time information is added when the frame is recorded. Video information management means divides such prerecorded video information into sectional video streams, each of which is associated with a specific link. This is done by retrieving corresponding link information from the road map management means by using simultaneously recorded positional information as a key. Each sectional video stream is stored together with positional information, time information and corresponding link information. On the other hand, to allow reference from link information to video information, the road map management means stores link-based reference information sorted by video availability, recorded date/time and the like. By using the road map management means and the video information management means mentioned above, it is possible to record and manage any video information including positional and time information in association with road information. The following summarizes the present invention.

According to one aspect of the present invention, there is provided a video delivery apparatus having roadmap data stored therein, comprising video edit means which: takes in video information recorded with image pickup duration information along roads and positional information and time information measured concurrently with the video information; compares positions in the roadmap data with the measured positions; compares image pickup duration information with time at which the associated position have measured; and associates pieces of the video information, defined by the associated respective periods of image pickup duration, with the corresponding positions in the roadmap data.

Preferably, the positions in the roadmap data are sorted by specific points and the video information is divided according to selectable areas indicated on the roadmap. To carry out the division, a selectable area selected on a roadmap may be displayed.

According to another aspect of the present invention, there is provided a video delivery apparatus wherein video information prerecorded in association with positions in roadmap data is replayed. The video delivery apparatus includes a video processing means which: takes in a specified route in the roadmap data and a specified moving speed; determines a position on the route based on the moving speed; and replays the video information corresponding to the position on the route.

Preferably, the video information has image pickup time information and the time information is used to reference sectional video data into which the video information is divided for display.

Preferably, the video information recorded along roads is divided into sectional video data by each road connecting turning points and sectional video data is replayed when specified.

Preferably, when the position at which the video information is to be replayed satisfies specific conditions, the replay speed associated with the replay-position is changed with respect to the moving speed.

Preferably, when video information recorded in front of a turning point is replayed, the next route can be specified or otherwise determined according to a pre-specified priority order and subsequently the video information for the specified road is replayed.

Preferably, the stored roadmap data include roadside facilities information and, when video information recorded along roads is replayed, the roadside facilities information is superimposed on the video information.

The operation of the present invention will thereinafter be explained. To generate and deliver video information as requested by the user, the above-mentioned video delivery apparatus takes in route information involving one or more links and a moving speed as inputs. First, the video delivery apparatus selects links one by one from the start point of the route toward the destination and extracts sectional video information corresponding to each link. The apparatus determines which frame is to be displayed next so that the replayed image moves consistently with the input moving speed information. This is done by calculating the time corresponding to the frame according to the positional information managed in combination with the sectional video information and the input moving speed information. The apparatus generates an image from the selected frame and repeats this until the end of the link at which the apparatus again begins to repeat the same processing for the next link selected.

To allow the user to select route information to be input to the video delivery apparatus, the apparatus indicates roadmap information to the user so that a link can be selected using a pointing device or the like. Practically, link selection may be designed in such a manner that the apparatus searches for candidate shortest routes between a starting point and a destination designated by the user by using distance as the index for evaluation and presents them to the user or a series of links traced on the roadmap with the pointing device are determined as a route.

In addition, to allow the user to select moving speed information to be input to the video delivery apparatus, the apparatus provides speed setting buttons and determines the moving speed according to the selected button. Speed setting may also be designed in such a manner that the user directly types in a speed value or legal limits are set to the respective links as attribute information and those values are used as the moving speed information for the respective links.

Meanwhile, the driver performs accelerating, decelerating and steering operations while driving the vehicle. To replay video consistently with this actual driving behavior, the moving speed information set as mentioned above must be changed dynamically where such operations are done. For this purpose, decelerating and accelerating patterns are registered in advance. For every two adjacent links, the apparatus determines whether such patterns are registered and, if registered, changes the moving speed information according to the registered patterns.

The video delivery apparatus exchanges information realtime with the external. Live video information and positional information are received from the external. The apparatus displays the video information and at the same time indicates the current position on the roadmap. Further, receiving voice information and destination/route information, the apparatus outputs the voice information from a speaker and superimpose the destination/route information on the roadmap.

In order that the operator who is visually checking the displayed information can give advice by voice to the information transmitter, voice of the operator is picked up by a microphone and sent to the information transmitter via communication means. If voice information or destination information is received from the information transmitter, the apparatus is instructed by the operator to select and display corresponding video information according to route information set by the operator according to the destination (or route information is directly set if received).

Further, the operator can instruct the apparatus to calculate/display the distance between two points specified by the operator or registered in advance as marks on the roadmap and the time required to travel the distance at a pre-determined speed based on the positional information stored therein and received from the information transmitter so that the operator can give advice.

### BRIEF DESCRIPTION OF THE DRAWINGS

Other objects and advantages of the invention will become apparent from the following description of embodiments with reference to the accompanying drawings in which:

FIG. 1 shows a basic configuration of a video delivery apparatus according to an embodiment of the present invention;

FIG. 2 shows a configuration of a roadmap data file;

FIG. 3 shows a configuration of a road network;

FIG. 4 shows a data organization of a link basic information file constituting a road network;

FIG. 5 shows a data organization of a node basic information file constituting a road network;

FIG. 6 shows a data organization of a link extended information file constituting a road network;

FIG. 7 shows a data organization of an attribute information file concerning roadside facilities;

FIG. 8 shows a configuration of a video-related data file;

FIG. 9 shows a data organization of a video information file;

FIG. 10 shows displayed contents consisting of detected positional information superimposed on link information;

FIG. 11 shows a data organization of a positional information file;

FIG. 12 shows a data organization of a positional information file cut out for a specific link;

FIG. 13 is a schematic diagram showing an operator main window for operating a video delivery apparatus;

FIG. 14 a schematic diagram showing a roadmap display window displayed in the operator main window;

FIG. 15 a schematic diagram showing a video display window displayed in the operator main window;

FIG. 16 is a flowchart indicating flows of processing by a video delivery apparatus;

FIG. 17 a schematic diagram showing a roadmap select window;

FIG. 18 is a flowchart indicating flows of processing through the roadmap select window;

FIG. 19 is a schematic diagram showing a source video select window displayed on an operator display;

FIG. 20 is a flowchart indicating the initial flows of processing through the source video select window;

FIG. 21 is a flowchart indicating flows of processing through a video tool of the source video select window;

FIG. 22 is a diagram showing a roadmap display window when both on-map display and numerical display are selected by a position tool of the source video select window;

FIG. 23 is a flowchart indicating flows of processing through the position tool of the source video select window;

FIG. 24 is a schematic diagram showing a video edit window displayed on an operator display;

FIG. 25 is a flowchart indicating the initial flows of processing through the video edit window;

FIG. 26 is a flowchart indicating flows of processing for positional correction;

FIG. 27 is a diagram showing a roadmap display in which corrected positional information is provided;

FIG. 28 is a flowchart indicating flows of processing for video division;

FIG. 29 is a flowchart indicating flows of processing through a video tool of the video edit window;

FIG. 30 a schematic diagram showing how reproduced images are selected to replay the video consistent with a specified speed.

FIG. 31 is a flowchart indicating flows of processing for speed-synchronized replay;

FIG. 32 shows a configuration of a video delivery apparatus and its user main window;

FIG. 33 is a flowchart indicating flows of processing through the video delivery apparatus by the user;

FIG. 34 is a diagram showing a roadmap display window displayed on the user display;

FIG. 35 is a flowchart indicating flows of processing through a route tool of the user main window;

FIG. 36 is a schematic diagram showing a roadmap display window when the route tool is operated;

FIG. 37 is a flowchart indicating flows of processing through a video tool of the user main window;

FIG. 38 is a flowchart indicating flows of processing for speed-synchronized replay;

FIG. 39 is a schematic diagram showing a video display window for the user when auto-cruise is selected;

FIG. 40 shows a configuration of a video delivery system comprising a video delivery apparatus connected with a user terminal apparatus;

FIG. 41 shows a configuration of a video delivery system comprising a video delivery apparatus connected with a data transmission apparatus;

FIG. 42 is a schematic diagram showing a data transmission window of the data transmission apparatus;

FIG. 43 shows a configuration of a video delivery system comprising a video delivery apparatus connected with an image pickup apparatus;

FIG. 44 shows a configuration of a video delivery system comprising a video delivery apparatus, a data transmission apparatus, a data reception apparatus, image pickup apparatuses and user terminal apparatuses which are connected via a communication network;

FIG. 45 is a diagram showing a roadmap display window where the locations of a still-image camera and a fixed-point live camera are superimposed;

FIG. 46 shows a configuration of a fixed-point video data file;

FIG. 47 is a diagram showing a video display window where road attribute information is superimposed and its explanatory diagram;

FIG. 48 is a diagram showing detailed road attribute information displayed in the video display window;

FIG. 49 shows a configuration of a video delivery apparatus and its guide main window;

FIG. 50 is a diagram showing a roadmap display window displayed on the guide display;

FIG. 51 is a diagram showing a video display window displayed on the guide display;

FIG. 52 is a diagram showing the video display window displayed on the guide display where video from the service recipient side is displayed;

FIG. 53 is a flowchart indicating flows of processing executed in response to the operations of the guide; and

FIG. 54 shows an example configuration for exchange of information and fees among video information suppliers, a video information collector/deliverer and video information users.

### DETAILED DESCRIPTION OF THE PREFERRED EMBODIMENTS

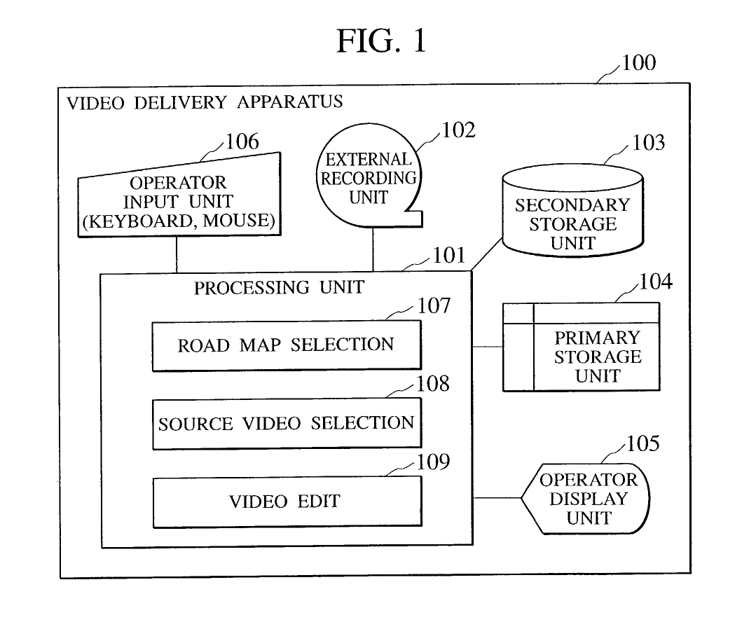

An embodiment of the present invention will be described in detail with reference to the drawings. FIG. 1 is a basic configuration of a video delivery apparatus according to the embodiment of the present invention. A video delivery apparatus 100 includes a processing unit 101, an external recording unit 102, a secondary storage unit 103 consisting of hard disks, etc., a primary storage unit 104 consisting of semiconductor memories, etc., an operator display unit 105 consisting of a display, etc. and an operator input unit 106 consisting of a keyboard, a mouse, etc.

The processing unit 101 includes a road map selection means 107 which selects map data from a plurality of map data as the data to be processed, video selection means 108 which selects video data from a plurality of source video data as the data to be processed, and a video edit means 109 which edits the selected video data. The external recording unit 102 reads road map data from optical disks, magnetic disks, etc. and video data from video tapes, etc.

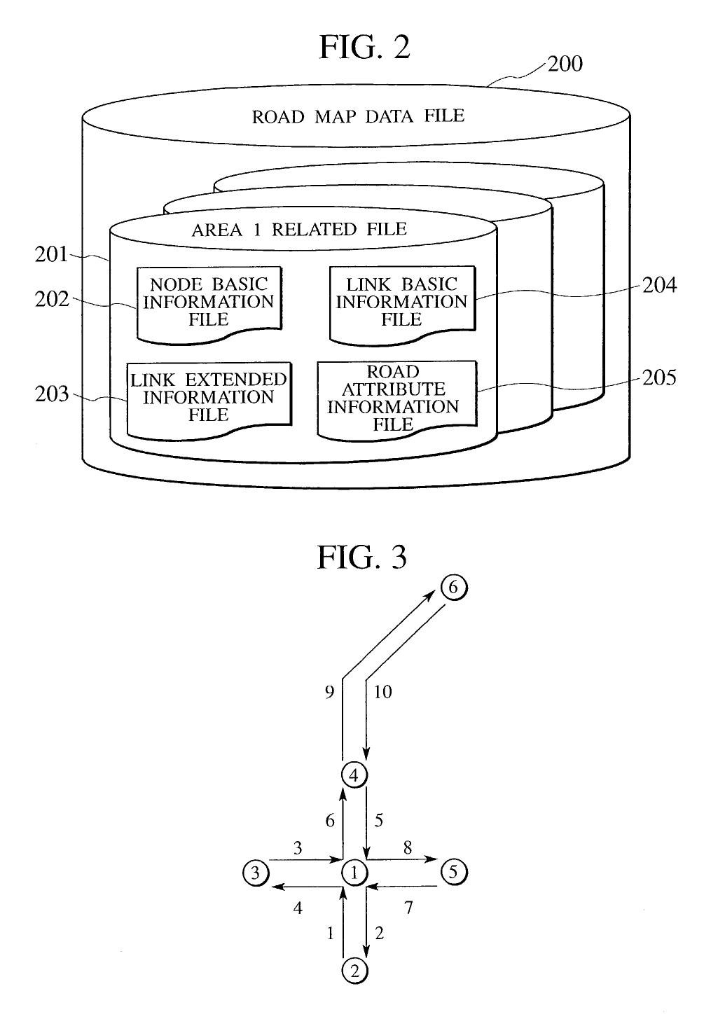

FIG. 2 is an example configuration of a road map data file. Of the information read from the external recording unit 102 into the secondary storage unit 103 in advance, this file contains road map information. The road map data file 200 contains the whole road network data divided into several area files 201. Each area file 201 consists of a node basic information file 202, a link basic information file 203, a link expanding information file 204 and a road attribute information file 205.

FIG. 3 is a diagram showing the definition of a road network. An intersection of roads is defined as a node and a road that connects intersections in either traffic direction is defined as a directional link by traveling direction of a vehicle. A network is defined by such nodes and links. The example in FIG. 3 shows a road network defined by six nodes \mathring{1} through \mathring{6} and ten links 1 through 10.

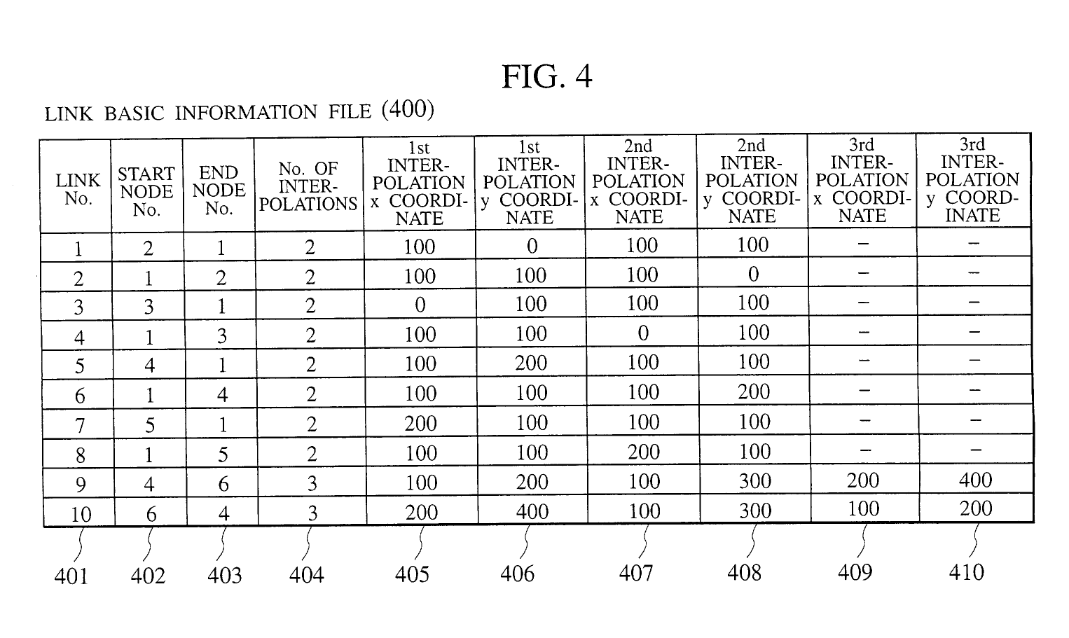

FIG. 4 shows a configuration of the link basic information file 400 which describes the links constituting the road network. Its format is shown in the form of a table. Viewed from left to right, the first column 401 in the table indicates the link No. of the link, column 402 the start node No. of the directional link and column 403 the end node No. of the directional link. Further, column 404 indicates the number of intersections (turning points) when a plurality of straight segments is used to approximate the link, columns 405 and 406 respectively the x and y coordinates of the first interpolation, columns 407 and 408 respectively the x and y coordinates of the second interpolation and, columns 409 and 410 respectively the x and y coordinates of the third interpolation.

Data in the file 400 definitely describes the links constituting the road network shown in FIG. 3. Although the number of interpolations is 3 at most in this table, this table can also be extended or designed variable in length so as to allow more interpolations.

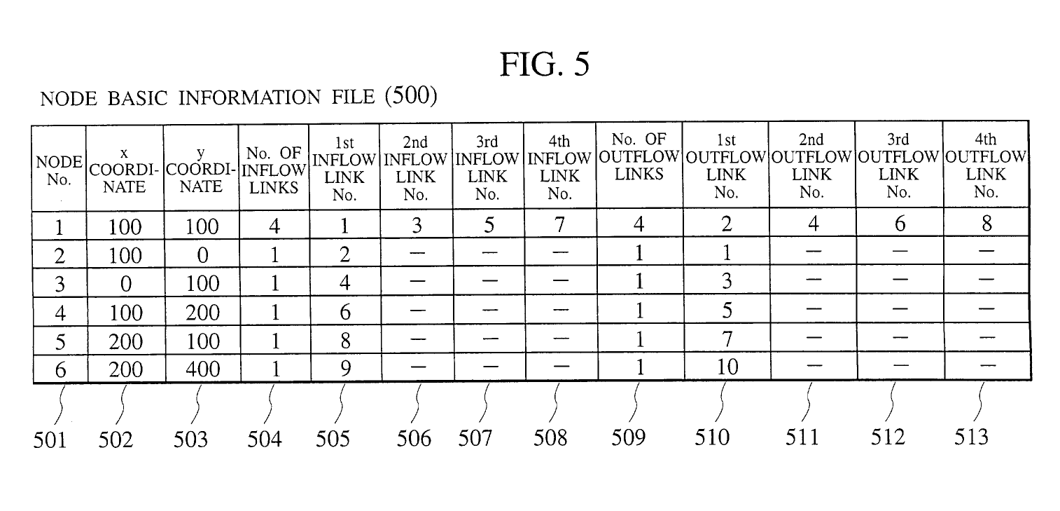

FIG. 5 shows a configuration of the node basic information file 500 describing the nodes constituting the road network. Its format is shown in the form of a table. Viewed from left to right, the first column 501 indicates the node No. of the node, columns 502 and 503 respectively the x and y coordinates of the node, column 504 the number of links which flow into the node, columns 505 through 508 respectively the link Nos. of the first, second, third and fourth inflow links, column 509 the number of links which flow out from the node and columns 510 through 513 respectively the link Nos. of the first, second, third and fourth outflow links.

Data in the file 500 definitely describes the nodes constituting the road network shown in FIG. 3. Although the number of either inflow or outflow links in this table is 4 at most, this table can also be extended or designed to be variable in length so as to support more links.

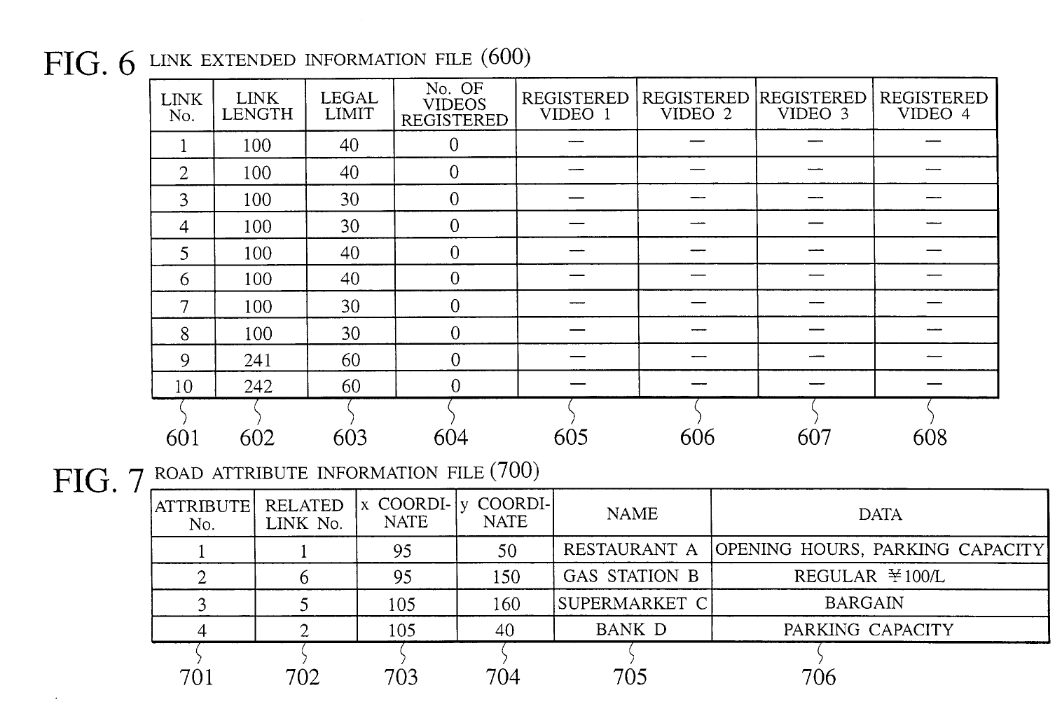

FIG. 6 shows a configuration of the link extended information file 600 describing the links constituting the road network. Extended information other than the basic information is stored in this file. Its format is shown in the form of a table. Viewed from left to right, the first column 601 indicates the link No. of the link, column 602 the length of the link and column 603 the legal limit there. The subsequent columns associate the link with video information. Column 604 indicates the number of videos registered for the link and columns 605 through 608 respectively the reference names of the first through fourth videos which are registered for the link. To refer to video information, filenames are used for example.

FIG. 7 shows a configuration of the road attribute information file 700 attached to the road network. Mainly it contains information about facilities along roads. Its format is indicated in the form of a table. Viewed from left to right, the first column 701 indicates the attribute No. of the attribute, column 702 the link No. of a link which is most related with the attribute, columns 703 and 704 respectively the x and y coordinates of the attribute, column 705 the name of the attribute, mainly the name of a roadside building and column 706 data other than the attribute name.

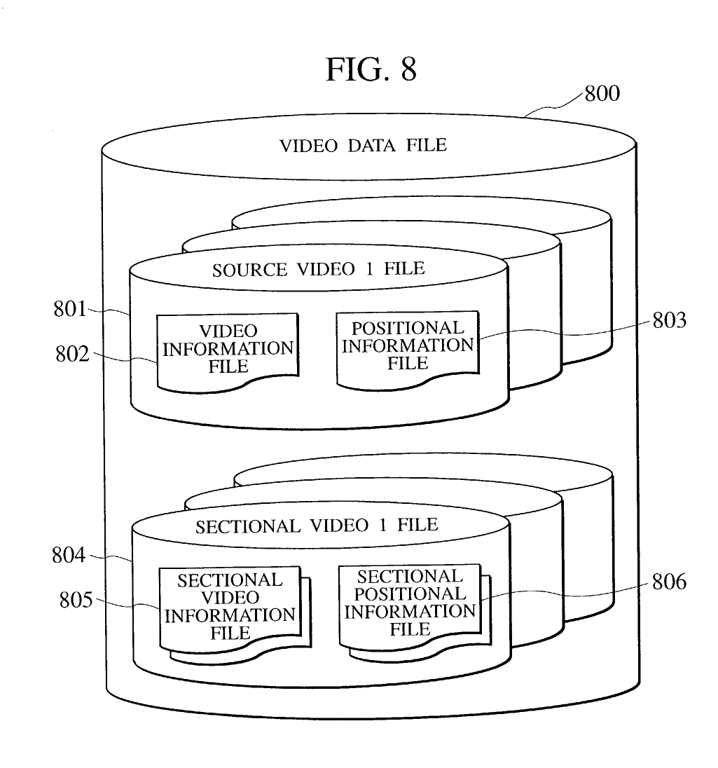

FIG. 8 is a configuration of a video data file 800. Of the information read from the external recording unit 102 into the secondary storage unit 103 in advance, this file contains video-related information. The video data file 800 contains a group of source video files and a group of sectional video files. A source video file 801 consists of a video information file 802 and positional information file 803. On the other hand, a sectional video file 804 which is for a specific link and cut out from the source video file group consists of a sectional video information file 805 and a sectional positional information file 806.

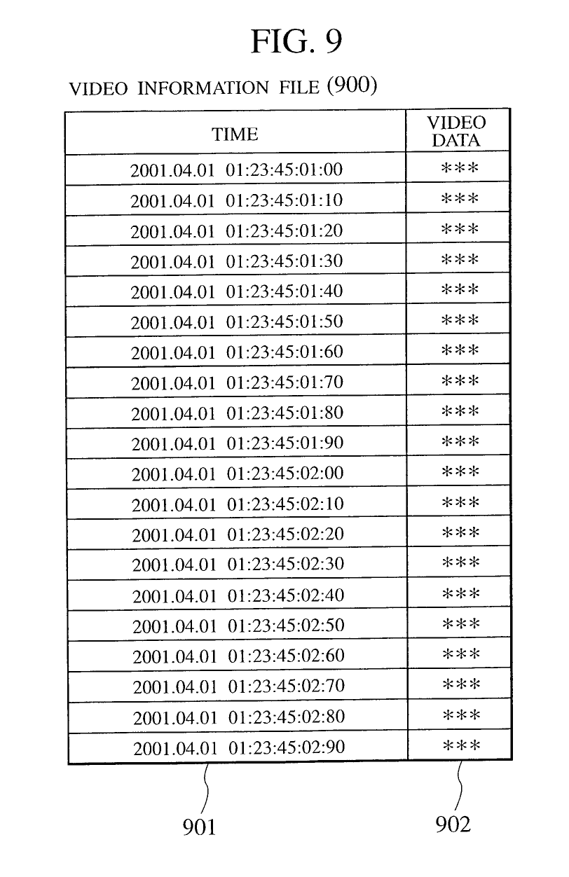

In the form of a table, FIG. 9 shows how video information is stored in a file. In the table 900, column 901 indicates when the video data is recorded and column 902 contains the video data recorded.

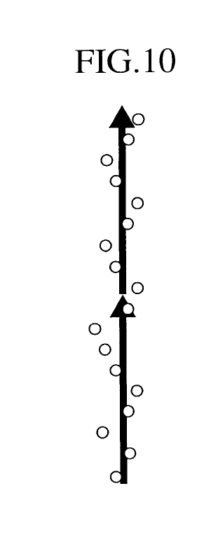

FIG. 10 is a schematic diagram where detected positional information is dotted along the link information defined for the road network. In this embodiment, positional information is obtained while image pickup is done using a video camera. For this purpose, positional information is periodically stored from a GPS receiver mounted near the video camera. Usually detected positional information includes an error regardless of whether the GPS is used or not. On the other hand, the road map data also includes an error because each link is defined by approximating an actual road with a plurality of straight segments. FIG. 10 indicates that the position detected by the GPS sometimes deviates from the link. This must be taken into consideration when video division processing, described later, is performed.

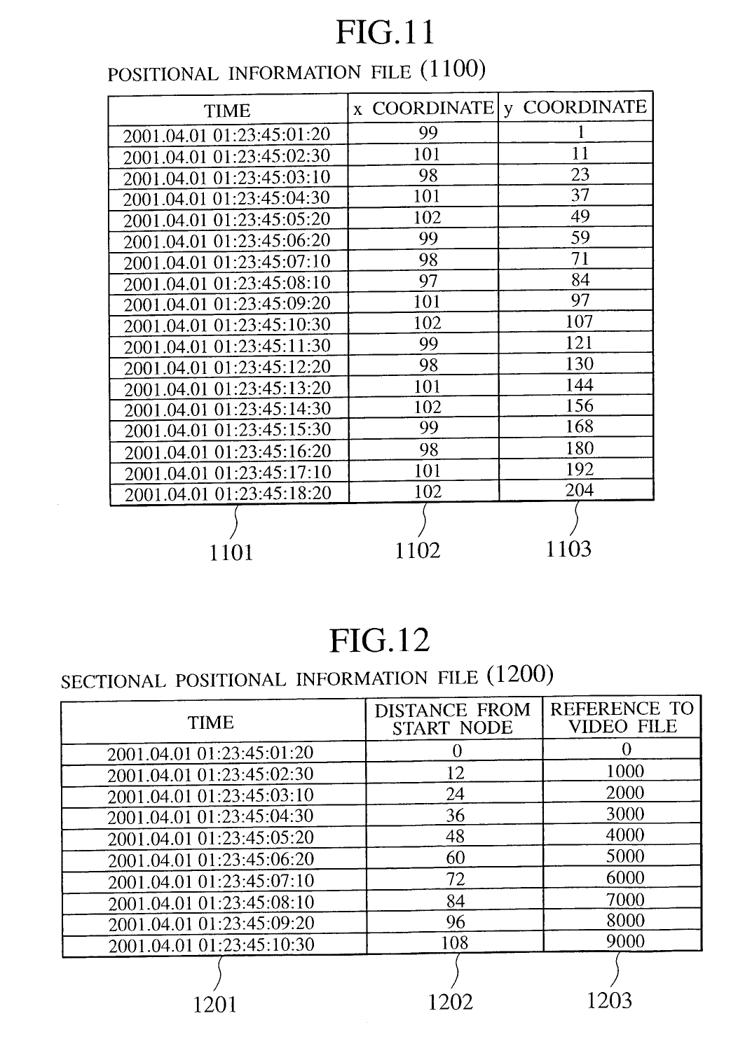

FIG. 11 shows a configuration of a positional information file 1100. Its format is shown in the form of a table. Viewed from left to right, the first column 1101 indicates when the position is detected and columns 1102 and 1103 respectively the x and y coordinates of the detected position. It is assumed here that the image recording interval in the video information file shown in FIG. 9 is independent of the detection interval in the positional information file shown in FIG. 11.

FIG. 12 shows a sectional positional information file 1200 prepared for a specific link in the road network. Its format is shown in the form of a table. As described later, sectional positional information files 1200 are prepared after position correction processing and video division processing are performed. Column 1201 indicates when the position is detected and column 1202 the distance from the start node of the link. Column 1203 refers to the corresponding image in the associated video information file by indicating the number of bytes from the top of the file. A description of the sectional video information file 805 is omitted here since its format is same as that of the video information file shown in FIG. 9.

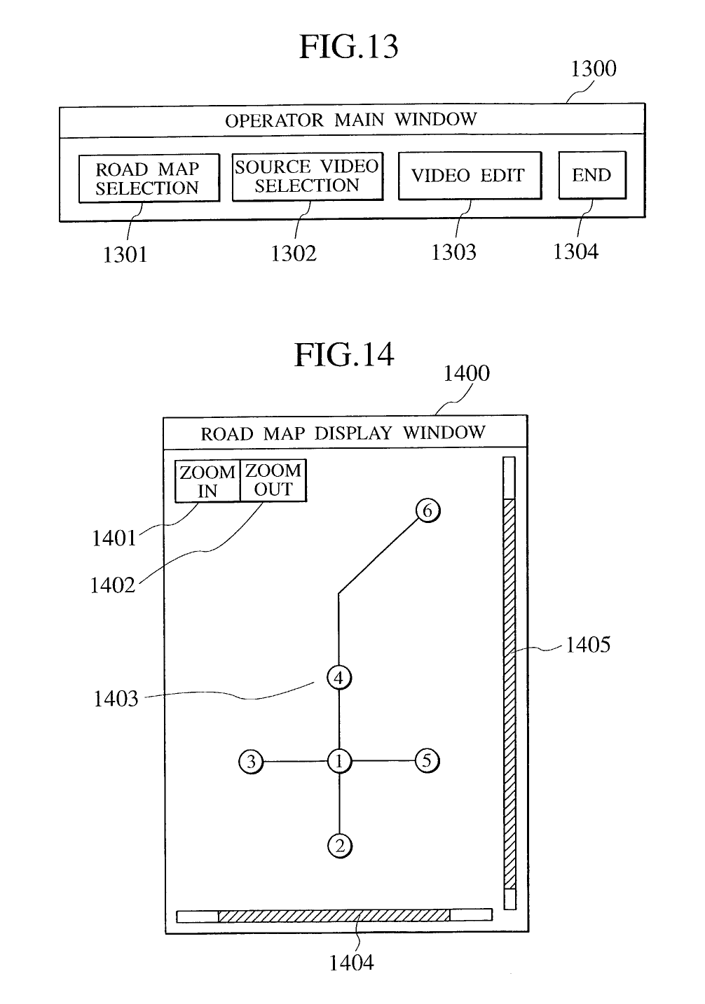

The operation of a video delivery apparatus in accordance with this embodiment will hereinafter be described. FIG. 13 shows an example of an operator main window used to operate the video delivery apparatus. The operator main window 1300 is displayed on the operator display unit 105 shown in FIG. 1 in order to support the operation of dividing gathered video information and positional information by link as defined by the road information and storing them. The main window 1300 is provided with a road map select button 1301, a source video select button 1302, a video edit button 1303, and an end button 1304. The buttons 1301 through 1303 respectively correspond to the road map selecting means 107, the source video selecting means 108 and the video edit means 109 in FIG. 1. The functions of these buttons can also be implemented in the form of a menu displayed in the window.

FIG. 14 is an example of a road map display window displayed for the operator who operates the video delivery apparatus. Together with the operator main window 1300 in FIG. 13, the road map display window 1400 is displayed on the operator display unit 105.

A road map is displayed if the map is selected after the road map select button 1301 in FIG. 13 is selected by a mouse of the operator input unit 106 in FIG. 1. The road map display window 1400 consists of a zoom in button 1401, a zoom out button 1402, a road map display area 1403, a horizontal slide 1404 and a vertical slide 1405. By selecting the zoom in button 1401 or zoom out button 1402, the operator can enlarge or reduce the displayed map at an internally preset ratio. If the displayed map is larger than the display area 1403, it is also possible to move the map so as to display the part of concern by using the horizontal slide 1404 or vertical slide 1405. In addition, nodes and links are displayed in the road map display area 1403 in such a manner that they can be distinguished from each other. It is also possible to display other information as a background image.

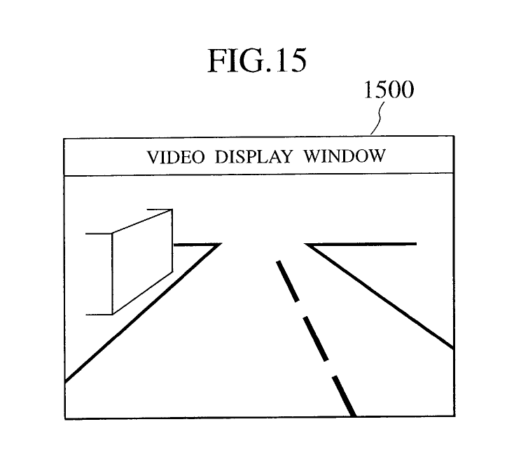

FIG. 15 is an example of a video display window displayed for the operator who operates the video delivery apparatus. Together with the operator main window 1300, the video display window 1500 is displayed on the operator display unit 105 shown in FIG. 1. A video is displayed if the video file is selected after the source video select button 1302 of FIG. 13 is selected through the operator input unit 106 of FIG. 1.

Although the operator main window of FIG. 13, the road map display window of FIG. 14 and the video display window of FIG. 15 are displayed separately in this embodiment, it is also possible to display all of them in a single window.

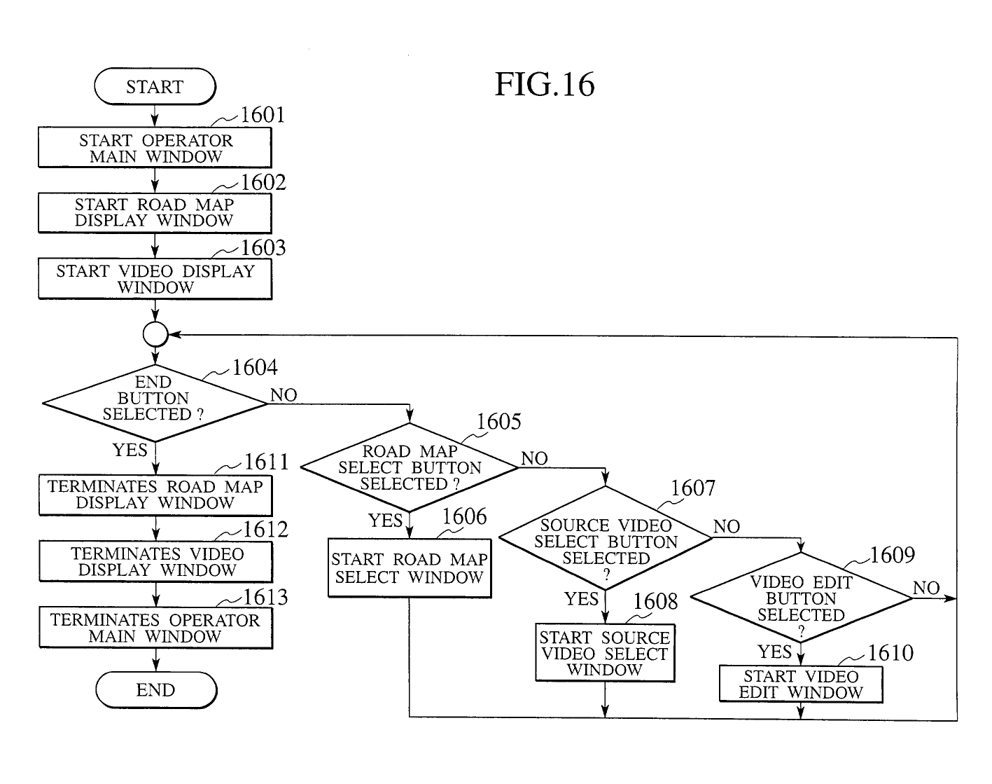

FIG. 16 is an example flowchart indicating how processing is executed in the video delivery apparatus. First, the video delivery apparatus starts the operator main window 1300 of FIG. 13 (1601), the road map display window 1400 of FIG. 14 (1602) and the video display window 1500 of FIG. 15 (1603) in this order as instructed by the operator. Then, the apparatus judges whether any of the end button 1304 (1604), the road map select button 1301 (1605), the source video select button 1302 (1607) and the video edit button 1304 (1609) is selected in the operator main window 1300.

If the end button 1304 is selected, the apparatus closes the road map display window (1611), the video display window (1612) and finally the operator main window (1613), terminating the whole processing concerning the operator main window. If the road select button 1301 is selected, the apparatus starts/displays the road map select window described later (1606). If the source video select button 1302 is selected, the source video select window described later is started/displayed (1608). If the video edit button 1303 is selected, the video edit window described later is started/displayed (1610). If any of the windows is opened, the apparatus judges the operator's next selection in the window opened.

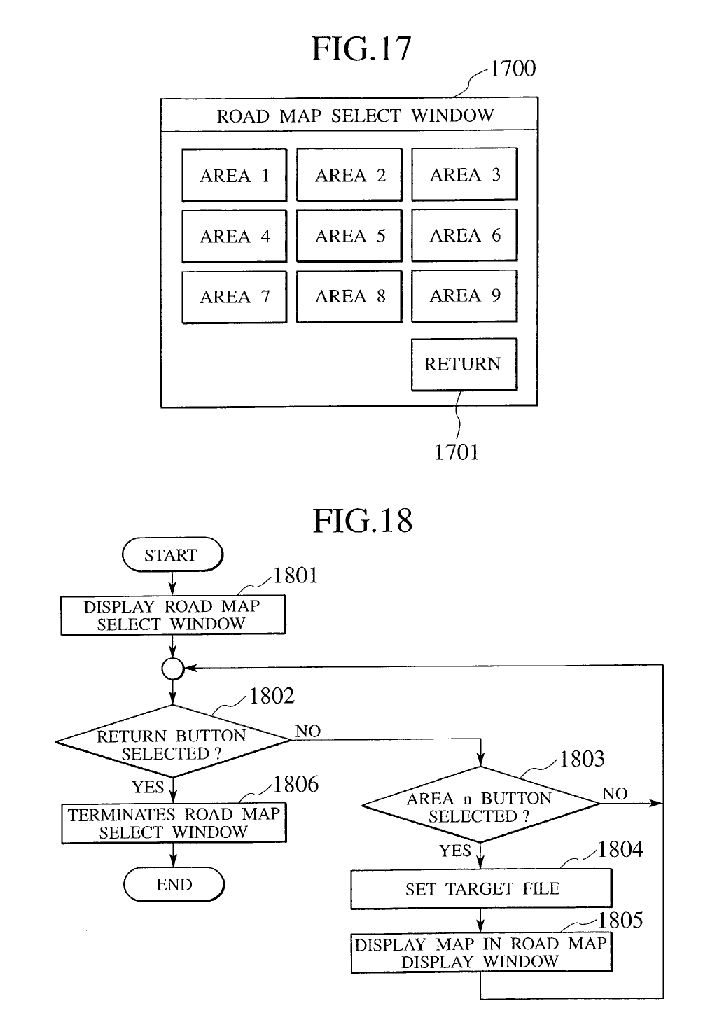

FIG. 17 shows an example of a road map select window. Started/displayed by processing 1606 under the operator's instruction, the road map select window 1700 has nine select buttons to choose from nine areas and a return button 1701 to terminate the window after a map is selected. On the area buttons, area names may be displayed as labels. It is also possible to attach map images to the buttons. Further, the window may be configured in such a manner that the whole map divided into several areas is displayed as an image to allow the operator to select an area by clicking it with a mouse. Selection from a list is also possible.

FIG. 18 is an example flowchart indicating how the road map select window is processed in response to the operator's operations. First, the video delivery apparatus displays the road map select window 1700 (1801). Then, it judges whether the return button 1701 is selected (1802) and then whether any area select button is selected (1803) in the window 1700. If the return button 1701 is selected, the road map select window is terminated (1806). If an area select button is found selected, the video delivery apparatus sets the corresponding road map file (1804), displays the road map in the road map display window of FIG. 14 (1805) and judges the operator's next selection.

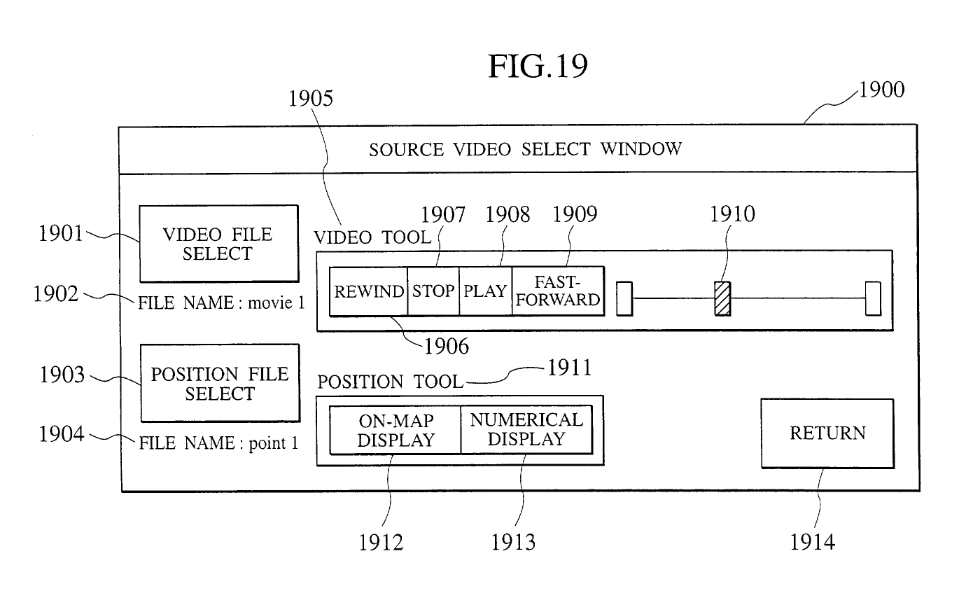

FIG. 19 is an example of a source video select window. Started/displayed by processing 1608, the source video select window 1900 is used by the operator to check video information and positional information. The source video select window 1900 consists of a video file select button 1901, a selected video file name display field 1902, a position file select button 1903, a selected position file name display field 1904, a video tool 1905, a position tool 1911 and a return button 1914. Further the video tool 1905 consists of a rewind button 1906, a stop button 1907, a play button 1908, a fast-forward button 1909 and a play position setting bar 1910, and the position tool 1911 consists of an on-map display button 1912 and a numerical display button 1913.

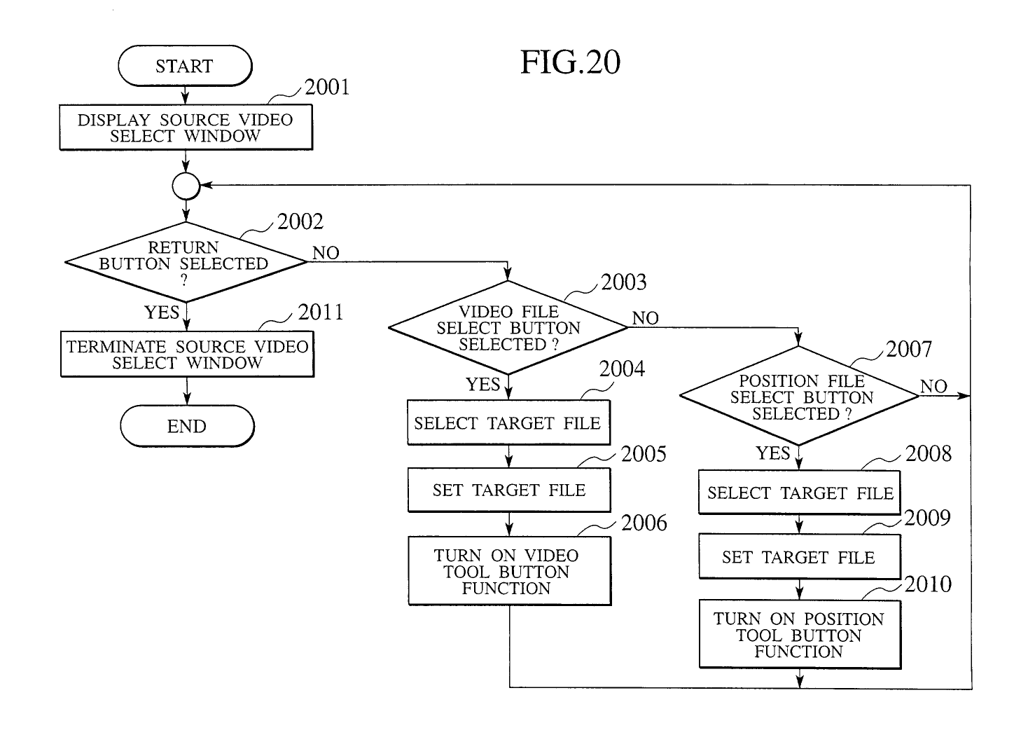

FIG. 20 is an example flowchart indicating how the source video select window is processed in response to the operator's operations. Initially, only the video file select button 1901, the position file select button 1903 and the return button 1914 can be selected in the started/displayed source video select window 1900.

First, the video delivery apparatus displays the source video select window (2001) and then judges whether the return button 1914 is selected (2002), whether the video file select button 1901 is selected (2003) and whether the position file select button is selected (2007). If the return button 1914 is found selected, the source video select window is terminated/erased to terminate the processing of the source video select window. If the video file select button 1901 is found selected, the video delivery apparatus urges the operator to directly type in a file name or select a file through a file select tool or the like (2004), sets the selected file internally (2005) and turns on the function of each button of the video tool, that is, makes each video button selectable (2006). Similarly, if the position file select button 1903 is found selected, the video delivery apparatus selects a target file (2008), sets it internally (2009) and turns on the function of each button of the position tool 1911 (2010). Subsequently in either case, the apparatus gets ready to judge the operator's next selection.

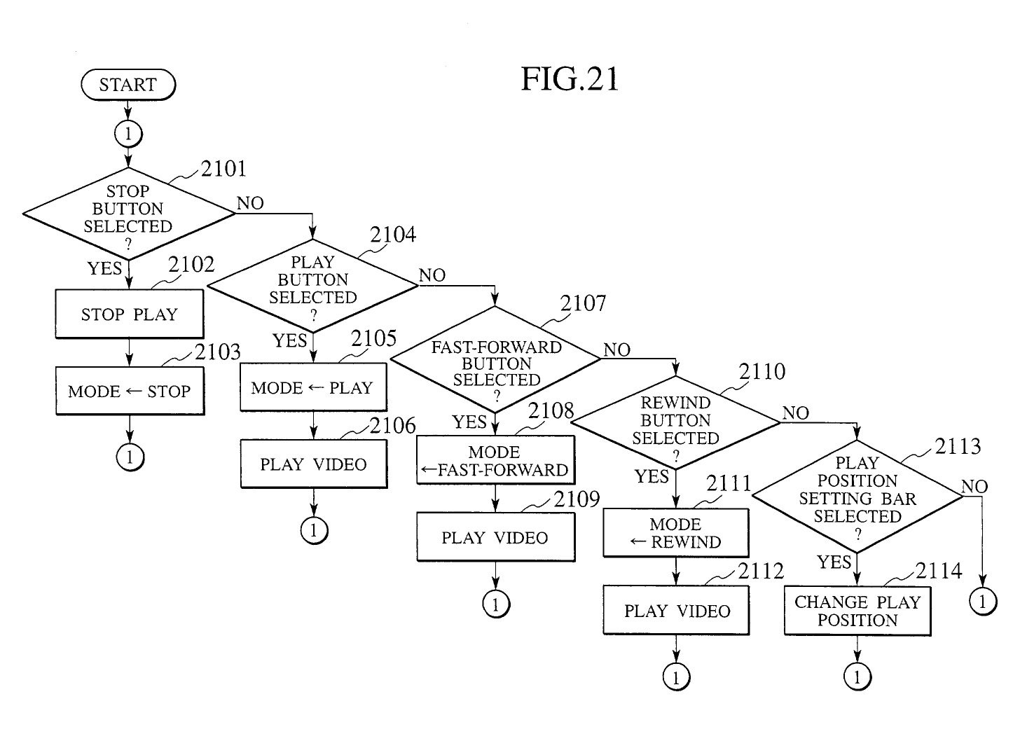

FIG. 21 is an example flowchart indicating how processing is executed in response to the operator's operations on the video tool in the source video select window. The video tool 1905 in FIG. 19 allows the operator to selectively use four buttons and one bar. First, the video delivery apparatus judges whether the stop button 1907 is selected (2101), whether the play button 1908 is selected (2104), whether the fast-forward button 1909 is selected (2107), whether the rewind button 1906 is selected (2110) and whether the play position setting bar 1910 is selected (2113).

If the stop button 1907 is found selected, the video delivery apparatus stops play, fast-forward or rewind (2102) and sets a value labeled “Mode” that means internal status to “stop” (2103). If the play button 1908 is found selected, the video delivery apparatus sets the mode to “play” (2105) and reproduce video (2106). If the fast-forward button 1909 is found selected, the video delivery apparatus sets the mode to “fast-forward” (2108) and reproduces video in this mode (2109). Similarly if the rewind button 1906 is found selected, the video delivery apparatus sets the mode to “rewind” (2111) and reproduces video in this mode (2112). If the play position setting bar 1910 is found selected, the video delivery apparatus allows the user to change the play position by moving the mouse (2114). Subsequently in either case, the video delivery apparatus gets ready to judge the operator's next selection. Note that video is reproduced by a widely known method consistent with the storage format such as MPEG, AVI or the like.

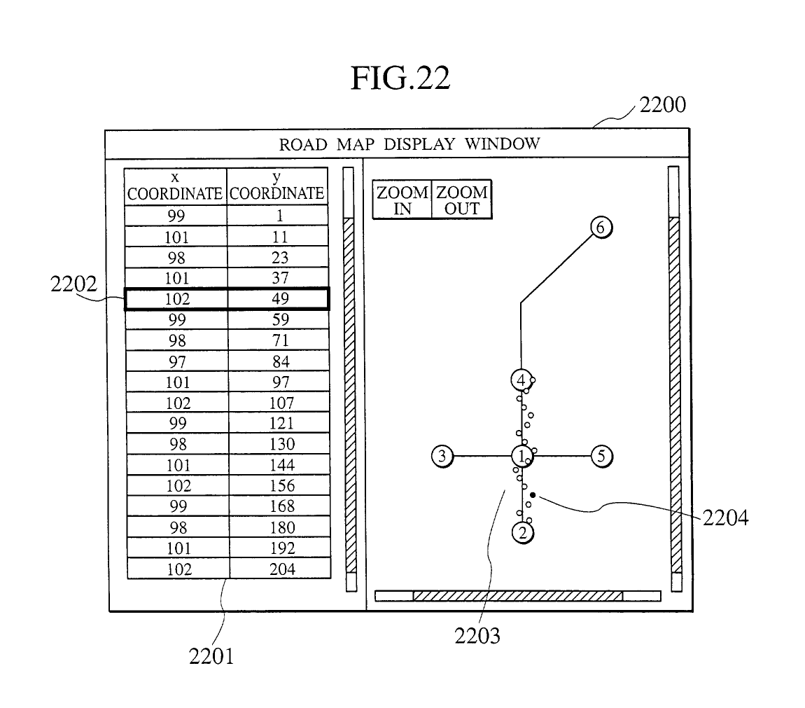

FIG. 22 is a road map display window opened from the source video select window. Contents of this example indicate that both on-map display and numerical display buttons are selected by the operator in the position tool 1911 of the source video select window 1900. If the on-map display button 1912 in FIG. 19 is selected by the operator, the road map display window 2200 superimposes positional information on the road map as shown by reference numeral 2203. On the other hand, if the numerical display button 1913 is selected, the window 2200 divides its display area into two partitions and displays the x and y coordinates of each point covered by the positional information in the form of a list as shown in a table 2201. If an item in the list is selected with the mouse, the data are highlighted and the corresponding position on the map is also highlighted by such a method as to change the color (2204).

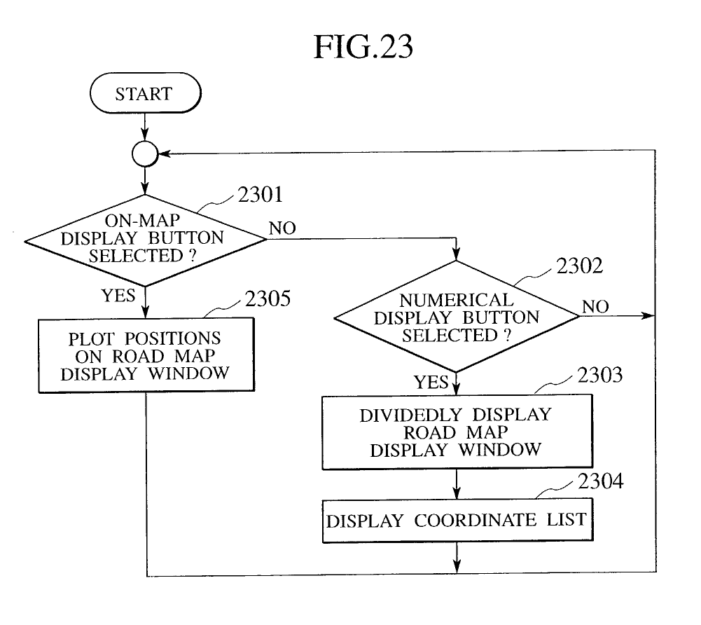

FIG. 23 is an example flowchart indicating how the road map display window shown in FIG. 22 is processed. The position tool 1911 in FIG. 19 allows the operator to select two buttons. Accordingly, the video delivery apparatus judges whether the on-map display button 1912 is selected (2301) and whether the numerical display button 1913 is selected (2302).

If the on-map display button 1912 is found selected, positional information is plotted as shown by reference numeral 2203 in the road map display window 2200 of FIG. 22 (2305). If the numerical display button 1913 is found selected, the video delivery apparatus divides the road map display window (2303) and displays a coordinate list of positions as shown in the table 2201 of the road map display window 2200. Subsequently in either case, the video delivery apparatus gets ready to judge the operator's next selection.

The on-map display button 1912 and the numerical display button 1913 can be selected independent of each other. In addition, either button becomes unselected if the button is selected again when it is already selected. Making the on-map display button unselected erases the plotted positions while making the numerical display button unselected erases the coordinate list and combines the partitions into one display area again.

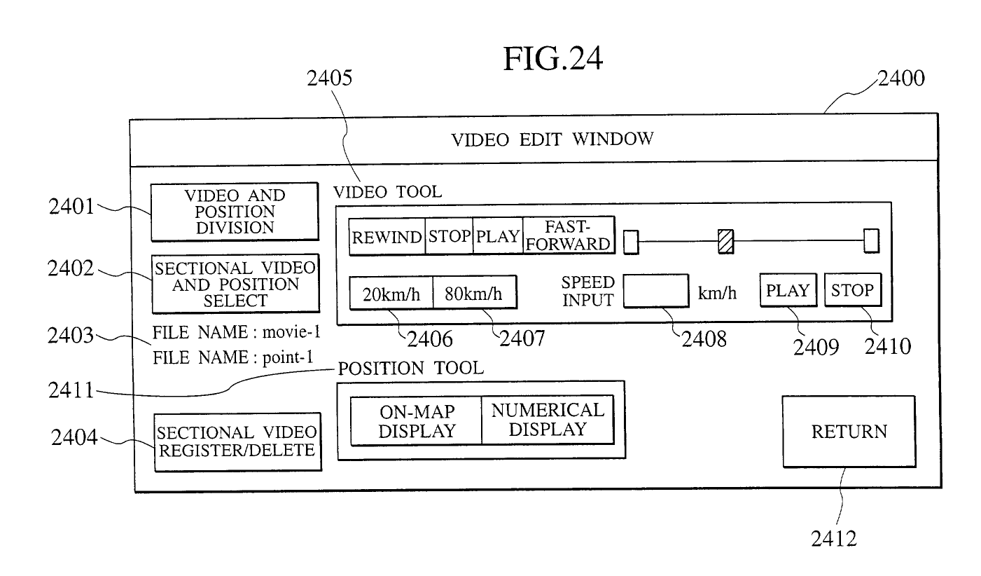

FIG. 24 is an example of a video edit window used to divide video information and positional information. The video edit window 2400 consists of a video and position division button 2401, a sectional video and position file select button 2402, a selected file name display field 2403 and a sectional file register/delete button 2404, a video tool 2405, a position tool 2411 and a return button 2412.

The video tool 2405 has a rewind button, a stop button, a play button, a fast-forward button and a play position setting bar which are respectively correspondent with the buttons and bar 1906, 1907, 1908, 1909 and 1910 of the video tool 1905 in FIG. 19 described earlier. Further, the window has a running speed 20 km/h specification button 2406, a running speed 80 km/h specification button 2407, a running speed input box 2408, a play button 2409 (for speed-specified replay) and a stop button 2410 (for speed-specified replay).

The position tool 2411 consists of an on-map display button and a numerical display button which are respectively correspondent with the buttons 1912 and 1913 of the position tool 1911 in FIG. 19 described earlier.

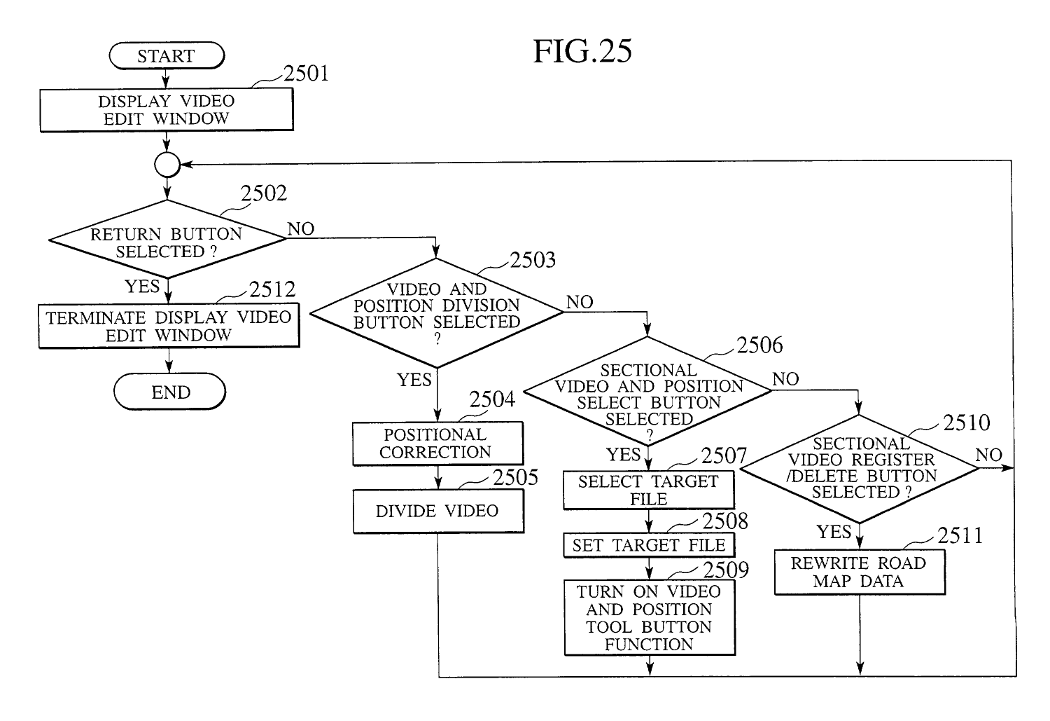

FIG. 25 shows the initial flows of the video edit window. When the video edit window 2400 is in the initial state, only the video and position division button 2401, the sectional video and position select button 2402, the sectional video register/delete button 2404 and the return button 2412 are selectable.

First, the video delivery apparatus displays the video edit window (2501) and then judges whether the return button 2412 is selected (2502), whether the video and position division button 2401 is selected (2503), whether the sectional video and position select button 2402 is selected (2506) and whether the sectional video register/delete button 2404 is selected (2510).

If the return button 2412 is found selected, the video delivery apparatus terminates/erases the video edit window (2512) to terminate the processing of the video edit window. If the video and position division button 2401 is found selected, the video delivery apparatus corrects position data which contain errors as illustrated in FIG. 10 and then divides the video data sequence into sectional video streams by link (2505). If a sectional video and position select button 2402 is found selected, the video delivery apparatus urges the operator to select a sectional video file and a sectional position file from the stored files (2507), sets the selected files internally (2508) and turns on the function of each button of the video tool 2405 and the position tool 2411 (2509). If the sectional video register/delete button 2404 is selected, the operator is urged to update the link extended information file in FIG. 6 described earlier. For registration, the operator increases the “No. of Videos Registered” and add the video No. of the video to be registered. For deletion, the operator decreases the “No. of Videos Registered” and deletes the registered video No. (2511). Subsequently in either case, the video delivery apparatus gets ready to judges the operator's selection.

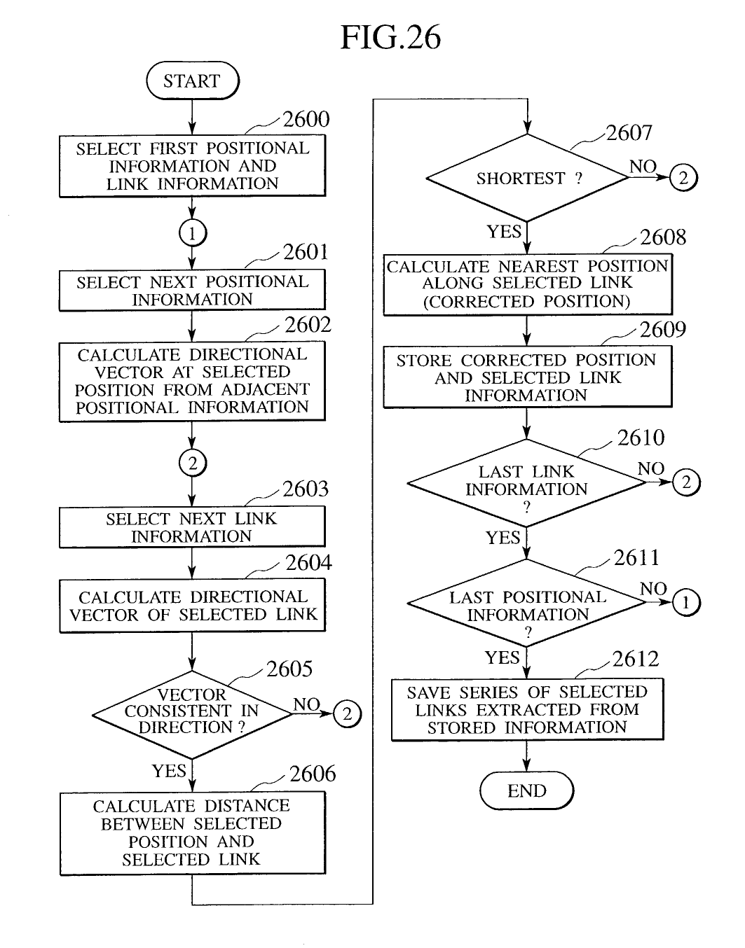

FIG. 26 is a detailed flowchart of the positional correction step 2504 shown in FIG. 25. First, the video edit means sequentially reads in the whole positional information file 1100 shown in the form of a table in FIG. 11 and the whole link basic information file 400 shown in FIG. 4 and selects the first positional information and the first link information (2600). Then, the video edit means selects the next positional information (2601) and calculates the directional vector at the selected position from the preceding positional information (2602). In the case of a road having opposite lanes, two links different in direction are defined between nodes. Taking such a case into consideration, this processing is done to identify which link is correspondent with the positional information. Then, starting to search all link information for the corresponding link, the video edit means selects the next link information (2603) and calculates the directional vector of the link (2604). Since each link is approximated by a plurality of straight segments, the directional vector is calculated for each straight segment. This processing may be skipped if the directional vectors of all straight segments are calculated and stored in memories or files in advance. Then, the video edit means judges whether the directional vector obtained in step 2602 matches with the directional vector obtained in step 2604 by calculating the inner product of the vectors (2605).

If the vectors do not match in direction, processing loops back to the step of selecting the next link. In this processing, it is possible that a distant link is selected and its directional vector matches. To prevent this and reduce the number of links to be examined, this processing loop may be designed in such a manner that an area is set around the position specified in step 2601 and processing at step 2604 is performed only for the links within the area. If the link is judged consistent in direction in step 2605, the video edit means calculates the distance to the straight segment constituting the link (2606). Then, the video edit means judges whether the distance is the shortest of all the distances calculated so far (2607) and, if not, processing loops back to the step of selecting the next link in order to search for the nearest link.

If the distance is shortest, the video edit means calculates the nearest position along the selected link (called the corrected position) (2608) and stores information such as the selected link, its distance, the corrected position and its distance from the start of the link (2609). By applying this judgement to all links (2610), the link information corresponding to one piece of positional information is obtained. This processing is applied to all positional information (2611). Finally, the video edit means extracts a series of selected links from the information stored in step 2609 and saves them into a memory or a file (2612).

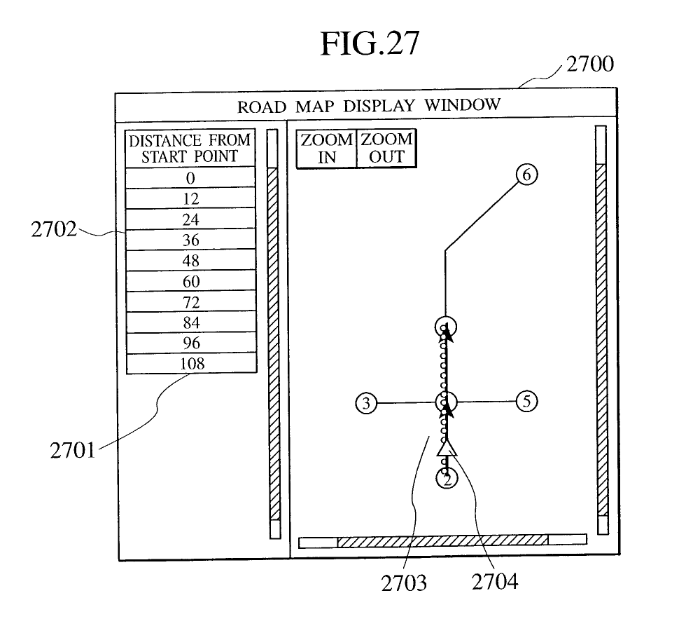

FIG. 27 shows example contents of the road map display window where positional information corrected by the positional correction processing is displayed. If the on-map display button and the numerical display button are selected in the position tool 2411 of FIG. 24, the road map display window 2700 is displayed. The display area is divided into two partitions. Corrected positions are plotted on the map as pointed out by reference numeral 2703 and the distance of each corrected position from the start point is displayed as a list as pointed out by a table 2701. Each entry of the list can be selected with the mouse. If selected, the selected information is highlighted as pointed out by reference numeral 2702 and the corresponding position on the road map is also differentiated from the other corrected positions, as pointed out by reference numeral 2704.

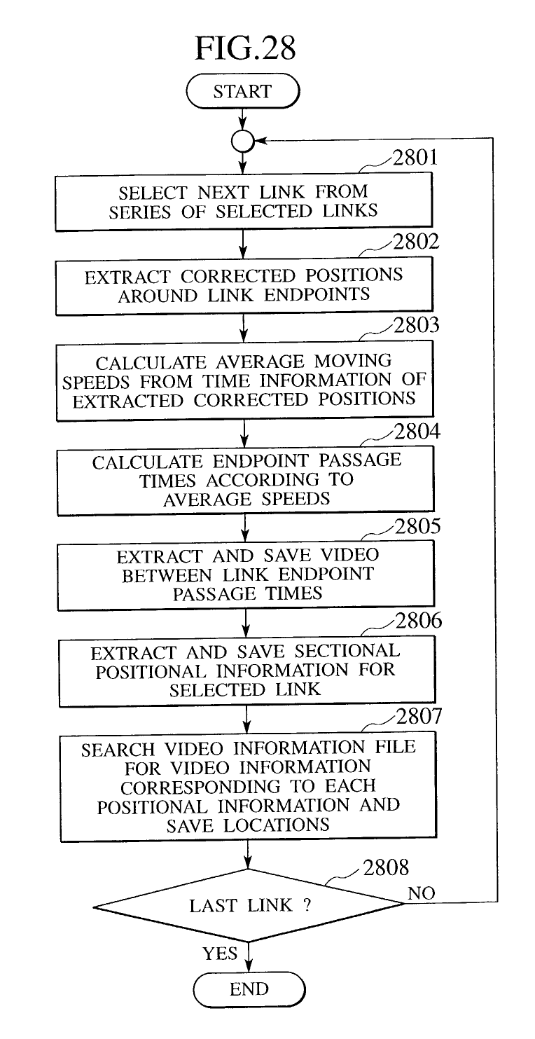

FIG. 28 shows a detailed flowchart of the video division step 2505 in FIG. 25. To divide the source video by link, the video edit means searches the source video for link endpoint images by using time information as the key. For extraction from the series of selected links saved in step 2612 in FIG. 26, links are selected one by one (2801). Since corrected positions in FIG. 26 do not always match with link endpoints as described above, the video edit means extracts corrected positions around the endpoints of the selected link from the series of corrected positions saved in the format shown in FIG. 12 (2802). Since the extracted corrected positions are associated with time information, the average moving speed can be calculated between two points (2803). From this obtained average moving speed, the time when an endpoint of the link is passed is obtained (2804). After obtaining the endpoint passage time on each side of the link by this method, the video edit means extracts a video stream between the two times from the video information file 900 shown in FIG. 9 and saves the extracted video stream into a sectional video information file (2805). Similarly, the video edit means extracts positional information by link and saves the extracted information into a sectional positional information file as shown in FIG. 12 (2806). Finally, the video edit means determines at what location the video information corresponding to each extracted positional information is present in the video information file and saves the obtained locations into column 1203 in FIG. 12. This processing is performed for all links (2808).

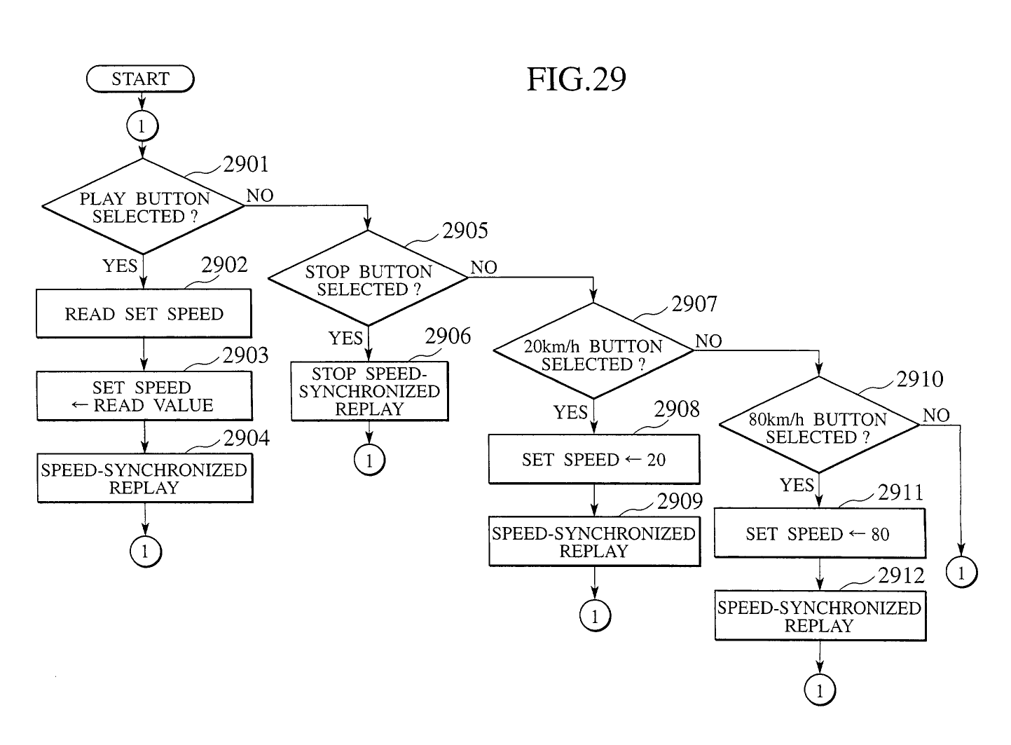

FIG. 29 is an example flowchart indicating how the video tool in the video edit window can be operated by the operator to execute processing. The rewind button, the stop button, the play button, the fast-forward button and the play position setting bar in the video tool 2405 in FIG. 24 have the same functions as those described with reference to FIG. 21. The following describes the other selectable four buttons and one input box.

The video edit means checks the video tool 2405 to judge whether the play button 2409 is selected (2901), whether the stop button 2410 is selected (2905), whether the 20 km/h button is selected (2907) and whether the 80 km/h button 2407 is selected (2910).

If the play button 2409 is found selected, the video edit means reads a set speed inputted into the speed input box from the keyboard (2902), sets the read value to the internal set speed (2903) and executes speed-synchronized replay processing described later (2904). If the stop button 2410 is selected, speed-synchronized replay is stopped if the processing is ongoing (2906). If the 20 km/h button 2406 is selected, the video edit means sets the corresponding value to the internal set speed (2908) and executes speed-synchronized replay (2909). Similarly if the 80 km/h button 2407 is selected, the video edit means set the corresponding value to the internal set speed (2911) and executes speed-synchronized replay (2912). Subsequently in either case, the video edit means gets ready to judge the operator's next selection. The 20 km/h button 2406 and the 80 km/h button 2407 may be changed to any other values by changing the settings and button labels.

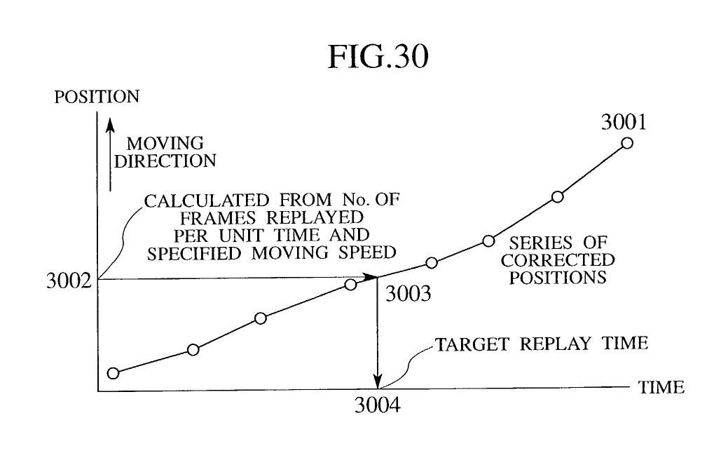

FIG. 30 is an explanatory diagram indicating how to determine which images are to be reproduced in synchronization with a set speed. In the diagram as a graph, the horizontal axis represents the time and the vertical axis displays the distance from the start point of the link or the route. Plotted there is a series of corrected positions 3001 obtained by executing the positional correction and the video division described respectively with reference to FIG. 26 and FIG. 28.

To replay video in synchronization with a specified moving speed, it is necessary to determine the next position on the vertical axis to be displayed based on the number of frames displayed per unit time and the specified moving speed and obtain the time corresponding to the position. Accordingly, a line graph is drawn on the assumption that the vehicle moved at a constant speed between corrected positions. Then the target replay time 3004 corresponding to the intersection 3003 is obtained and a frame nearest to the target replay time is selected.

Thus, according to this embodiment, since the next video information to be reproduced is determined in synchronization with the specified moving speed, video information can be displayed not depending on the situation when the video information has been obtained. For example, even if the image pickup vehicle continued to move slowly due to traffic congestion or the like, influence on the replayed video can be eliminated.

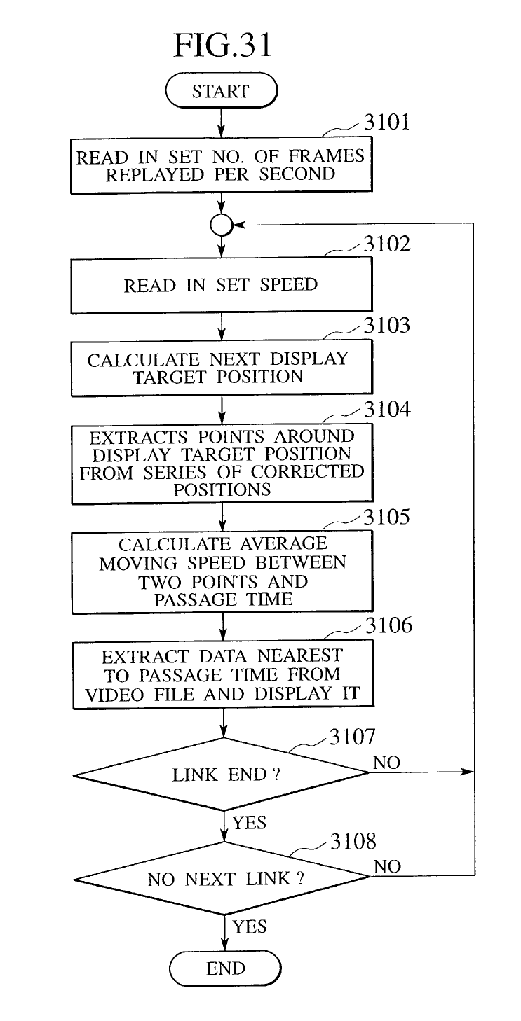

FIG. 31 shows a flowchart indicating how speed-synchronized replay is executed. First, to display images as a motion picture in the video display window 1500 described earlier with reference to FIG. 15, the video edit means reads in a value and sets it as the number of frames replayed per unit time (for example 1 second) (3101). This value may be either preset internally or varied depending on the communication speed selected by the user.

Then, the video edit means reads in the speed set by step 2903, 2908 or 2911 in FIG. 29 (3102) and calculate the next position to be displayed from the number of frames and the set speed as described above (3103). The video edit means extracts corrected positions around the display target position from the series of corrected positions (3104), calculates the average moving speed between two points from their positional and time information and calculates the display target point passage time (3105). Then, the video edit means extracts the data nearest to the passage time from the video file shown in FIG. 9 and displays the data in the video display window (3106).

If a road map display window as shown in FIG. 27 is displayed together with the video display window, the currently replayed position is indicated along the link with an on-map icon or the like and moved according to the progress of the motion picture. Processing is repeated until the end of the link (3107) and further repeated for the subsequent all rinks if replay along a plurality of links was specified, for example, in the form of route setting described later (3108).

Example processing flows to divide source video into sectional video streams by link and save them with positional information have been described so far. The following describes flows of processing required by the user to use the saved sectional video streams.

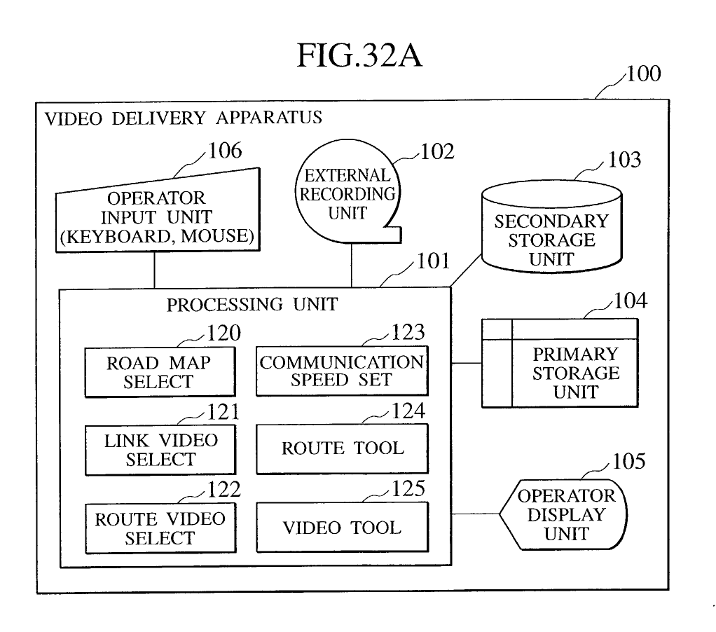

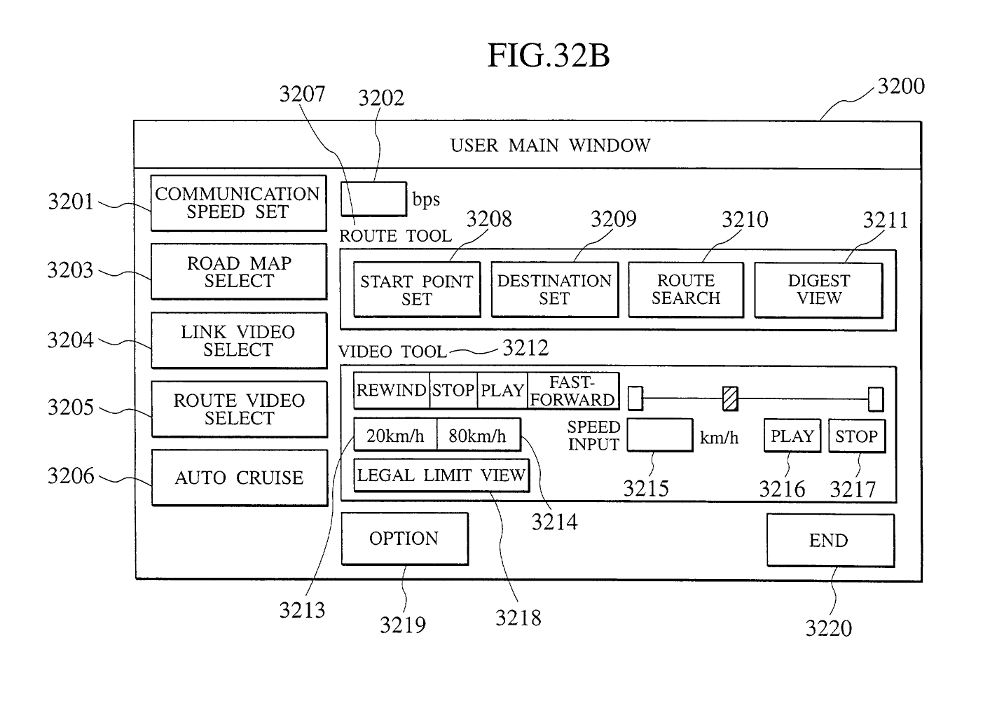

FIG. 32 shows a configuration of a video delivery apparatus used by the user and its user main window. A processing section in FIG. 32A is configured by modifying the functions of the processing section 101 in FIG. 1 so that divided and saved video data can be used by the user. The processing unit 101 includes a road map selecting means 120, a link video selecting means 121, a route video selecting means 122, a communication speed setting means 123, a route tool 124, and a video tool 125.

FIG. 32B is an example of a main window displayed on the display for the user who uses the video delivery apparatus. The user main window 3200 includes a communication speed setting button 3201, a communication speed input box 3202, a road map select button 3203, a link video select button 3204, a route video select button 3205, an auto cruise button 3206, a route tool 3207, a video tool 3212, an option button 3219 and an end button 3220. Some of the buttons are associated with the functions of the above means 120 through 125 in FIG. 32A.

Further, the route tool 3207 includes a start point setting button 3208, a destination-setting button 3209, a route search button 3210 and a digest view button 3211. The video tool 3212 has a legal limit view button 3213 in addition to those of the video tool 2405 in FIG. 24.

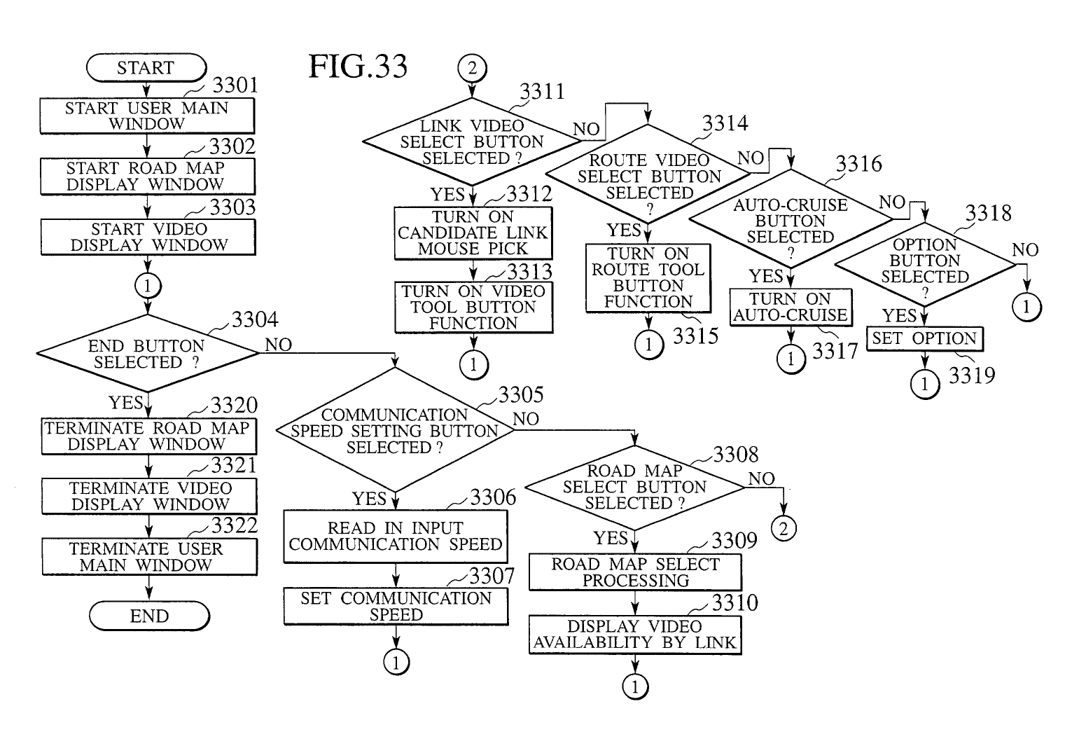

FIG. 33 is a flowchart indicating how processing is performed by the video delivery apparatus in response to the user's operations. The video delivery apparatus starts the user main window 3200 (3301), a window similar to the road map display window 1400 described with reference to FIG. 14 (3302) and a window similar to the video display window 1500 described with reference to FIG. 15 (3303) in this order.

Then, the video delivery apparatus checks the user main window 3200 to judge whether the end button 3220 is selected (3304), whether the communication speed setting button 3201 is selected (3305), whether the road map select button 3203 is selected (3308), whether the link video select button 3204 is selected (3311), whether the route video select button 3205 is selected (3314), whether the auto-cruise button 3206 is selected (3316) and whether the option button 3219 is selected (3318).

If the end button 3220 is found selected, the video delivery apparatus terminates/closes the road map display window (3320), the video display window (3321) and finally the user main window (3322) to terminate the whole processing concerning the user main window. If the communication speed setting button 3201 is selected, the video delivery apparatus reads in a speed inputted into the input box 3202 from the keyboard (3306) and sets the value internally as the communication speed (3307). If the road map select button 3203 is found selected, the video delivery apparatus allows the user to select a map as shown in FIG. 17 and FIG. 18 (3309) and indicates whether video is available on a link basis according to the registered video information in the link extended information file described with reference to FIG. 6 (3310).

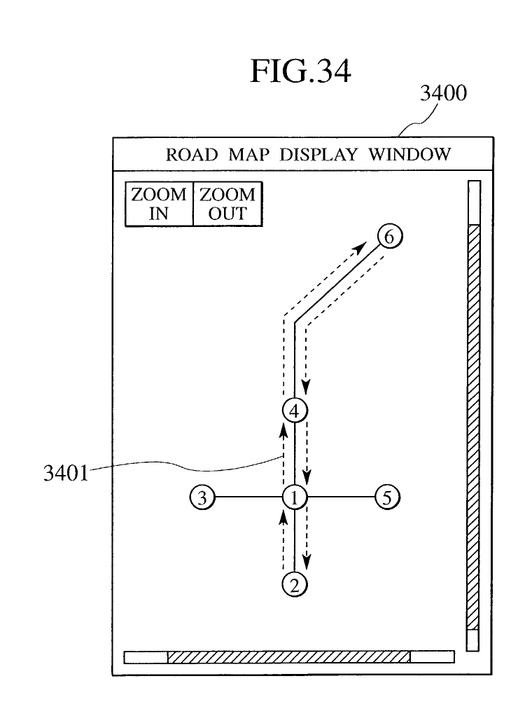

FIG. 34 shows example contents of the road map display window 3400. The arrow 3401 drawn by a broken line indicates that a video is registered for the link.

Then if the link video select button 3204 is found selected, the video delivery apparatus turns on the mouse pick function which allows the user to select a link from the video-registered candidate links through a mouse pick operation (3312) and turns on the function of each button of the video tool 3212 in FIG. 32 (3313). The mouse pick operation is to select an object in the display area. For example, the link 3401 in FIG. 34 can be set as a candidate link which may be picked. The mouse pick function can also be implemented in such a manner that a rectangle area is set around a directional link such as the link 3401 and the link is judged as selected if the mouse button is pushed in the rectangle area.

If the route video select button 3205 is found selected, the function of each button of the route tool 3207 in FIG. 32 is turned on (3315). If the auto-cruise button 3206 is found selected, the auto-cruise setting function is turned on for the processing described later (3317). If the option button 3219 is found selected, the user is allowed to set options (3319). The options the user sets may include settings for the rewind button, the fast-forward button, the 20 km/h button and the 80 km/h button of the video tool and for the route search function and the digest view function described later. Subsequently in either case, the video delivery apparatus gets ready to judge the user's next selection.

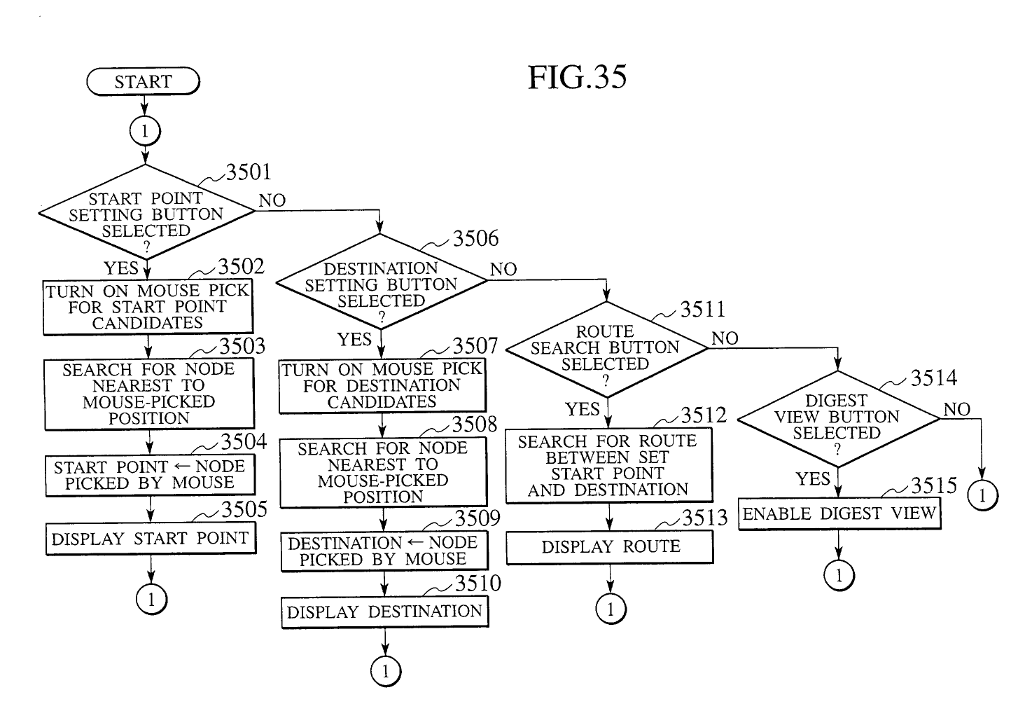

FIG. 35 is an example flowchart indicating how processing is executed in response to the user's operations on the route tool in the user main window. The route tool in FIG. 32 has four selectable buttons. First, the video delivery apparatus judges whether the start point setting button 3208 is selected (3501), whether the destination setting button 3209 is selected (3506), whether the route search button 3210 is selected (3511) and whether the digest view button 3211 is selected (3514).

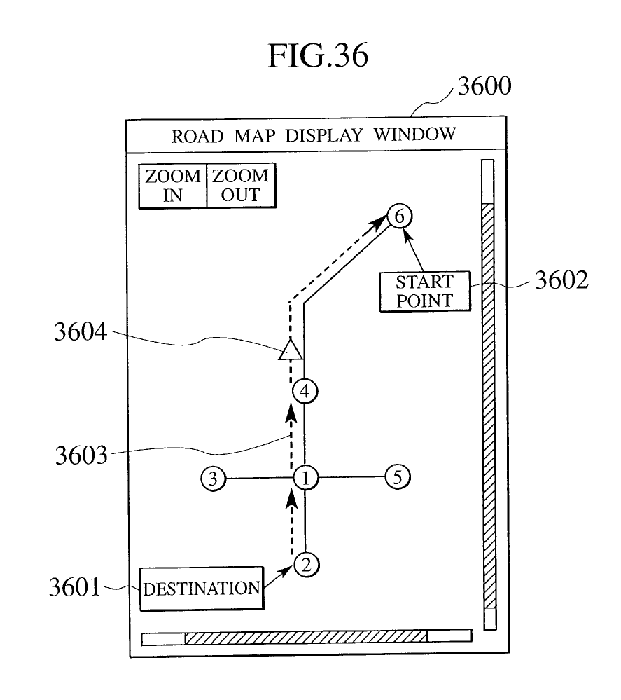

If the start point setting button 3208 is found selected, it is assumed that a start point is to be selected from nodes. The video delivery apparatus turns on the mouse pick function to allow the user to select a node from candidate nodes (3502), searches for a node nearest to the picked point (3503), sets the retrieved node as the start point (3504) and displays it with a tag “Start Point” 3601 in the road map display window 3600 as shown in FIG. 36 (3505). Similarly, if the destination setting button 3209 is selected, the video delivery apparatus turns on the mouse pick function to allow the user to select a node from candidate nodes (3507), searches for a node nearest to the picked point (3508), sets the retrieved node as the destination (3509) and displays it with a tag “Destination” 3602 in the road map display window 3600 as shown in FIG. 36 (3510).

If the route search button 3210 is found selected, the video delivery apparatus searches for a route between the start point set by step 3504 and the destination set by step 3509 (3512) and displays the route 3603 in the road map display window 3600 as shown in FIG. 36 (3513). Unless both start point and destination are set, however, processing goes back to the loop to judge the next selection after an error message is issued. The route search is implemented by using such an approach as the Dijkstra method. If the digest view button 3211 is found selected, the digest view is enabled for use in the processing described later (3515). Finally in either case, the video delivery apparatus gets ready to judges the user's next selection.

Other route setting methods are also possible. For example, it is possible to determine a route from a trace drawn with the mouse by the user along links on the map. In this case, the route can be obtained as a series of links as the result of using the positional correction method described in FIG. 26.

As described earlier, FIG. 36 shows example contents of the road map display window when the route tool is operated by the user. An icon 3604 indicates the current position of the video replayed by the user through the video tool 3212.

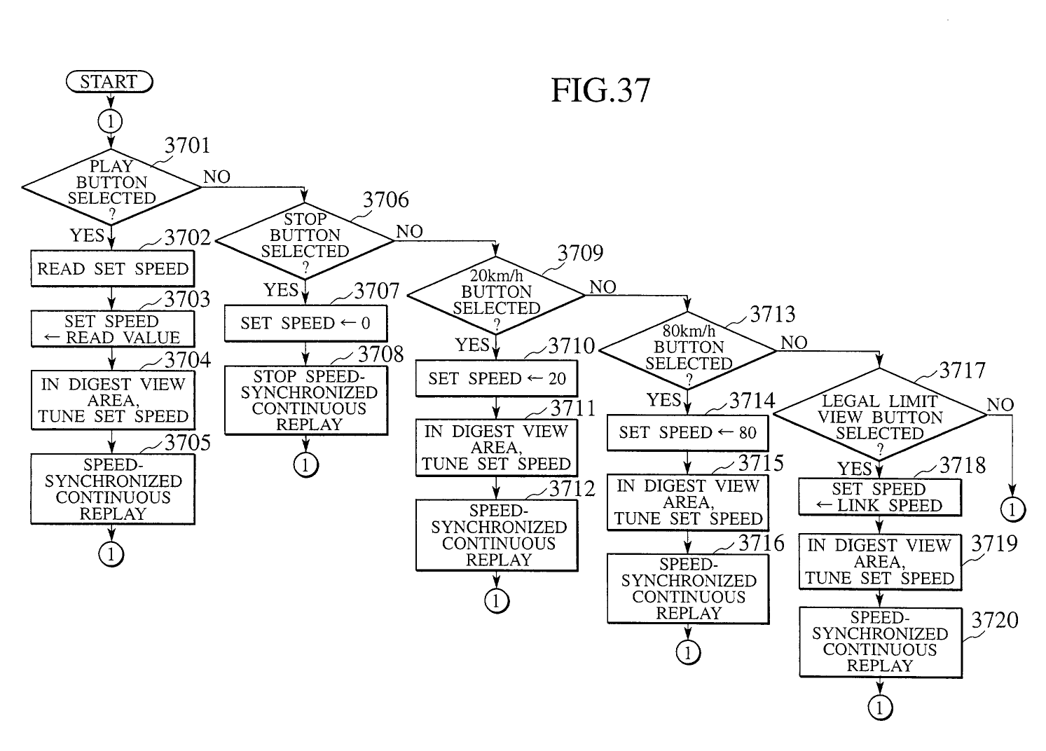

FIG. 37 is an example flowchart indicating how processing is executed in response to the user's operations on the video tool in the user main window. The play button, the stop button, the rewind button, fast-forward button and the play position setting bar of the video tool 3212 in FIG. 32 are used to replay the video at the same speed as recorded without synchronization with the moving speed. Their processing flows are the same as described in FIG. 21. The following describes the flows of processing executed when the other buttons are selected.

Although similar to that in FIG. 29, this flowchart is different in that the setting of the digest view and the setting of the legal limit are taken into consideration. Digest view is a function to replay video faster when the current position of the video is not in any of the preset areas such as a turning point area. Therefore, while video is replayed, the digest view must continue to check if the current position is in any of the digest view areas. It is also possible to introduce a driving-pattern model into the digest view. The following describes how the replay speed is determined by taking such a model into consideration.

To make a right or left turn at an intersection, the driver reduces the speed before turning and raises the speed to leave the intersection. To replay video consistent with the driving behavior, it is necessary to set a turning speed, a deceleration rate and an acceleration rate to each intersection and tune the selected moving speed so that the play speed is decreased in front of the intersection and raised after the intersection.

The first processing by the video delivery apparatus is to check the video tool of FIG. 32 to judge whether the play button 3216 is selected (3701), whether the stop button 3217 is selected (3706), whether the 20 km/h button 3213 is selected (3709), the 80 km/h button 3214 is selected (3713) and the legal limit view button 3218 is selected (3717).

If the play button 3216 is selected, the video delivery apparatus reads the set speed inputted into the speed input box 3215 from the keyboard (3702), sets the value internally as the moving speed (3703). If the current position of video is in a digest view area, the speed which has been set internally in step 3703 is, for example, doubled to raise the replay speed or tuned according to a driving-pattern model (3704). If not in a digest view area, the video delivery apparatus executes speed-synchronized continuous replay as described later (3705). If the stop button 3217 is found selected, the video delivery apparatus changes the set speed to 0 (3707) and stops the speed-synchronized continuous replay processing if ongoing (3708).

If the 20 km/h button 3213 is selected, the video delivery apparatus internally sets a value corresponding to 20 km/h (3710), performs digest view setting similar to step 3704 (3711) and executes speed-synchronized continuous replay (3712). Likewise, if the 80 km/h button 3214 is found selected, the video delivery apparatus internally sets a value corresponding to 80 km/h (3714), performs digest view setting similar to step 3704 (3715) and executes speed-synchronized continuous replay (3716).

In the legal limit view mode, the legal limit is set as the moving speed for each link. If the legal limit view button 3218 is found selected, the video delivery apparatus sets the pertinent legal limit to each link according to the link extended information file 603 in FIG. 6 (3718), performs digest view setting similar to step 3704 (3719) and executes speed-synchronized continuous replay (3720). Finally in either case, the video delivery apparatus gets ready to judge the user's next selection.

FIG. 38 is an example flowchart indicating how speed-synchronized continuous replay is executed. Although similar to that described in FIG. 31, this flowchart is different in that the setting of the auto cruise mode and its route setting link select steps are taken into consideration. First, to display images as a motion picture in the video display window described earlier with reference to FIG. 15, the video delivery apparatus reads in a value and sets it as the number of frames replayed per second (3801). This value may be either preset internally or varied depending on the communication speed selected by the user through the communication speed setting button 3201 in FIG. 32.

Then, the delivery apparatus reads in the set speed described in FIG. 37 (3802) and calculates the next position to be displayed (3803) The video display apparatus extracts corrected positions around the display target position from a series of corrected positions (3804), calculates the average moving speed between two points from their positional and time information and calculates the display target point passage time (3805). Then, the video delivery apparatus extracts the data nearest to the passage time from the video file and displays the data in the video display window (3806). At this time, if a road map display window as shown in FIG. 36 is present together with the video display window, the currently replayed position is indicated along the link with an on-map icon 3604 which moves according to the progress of the motion picture.

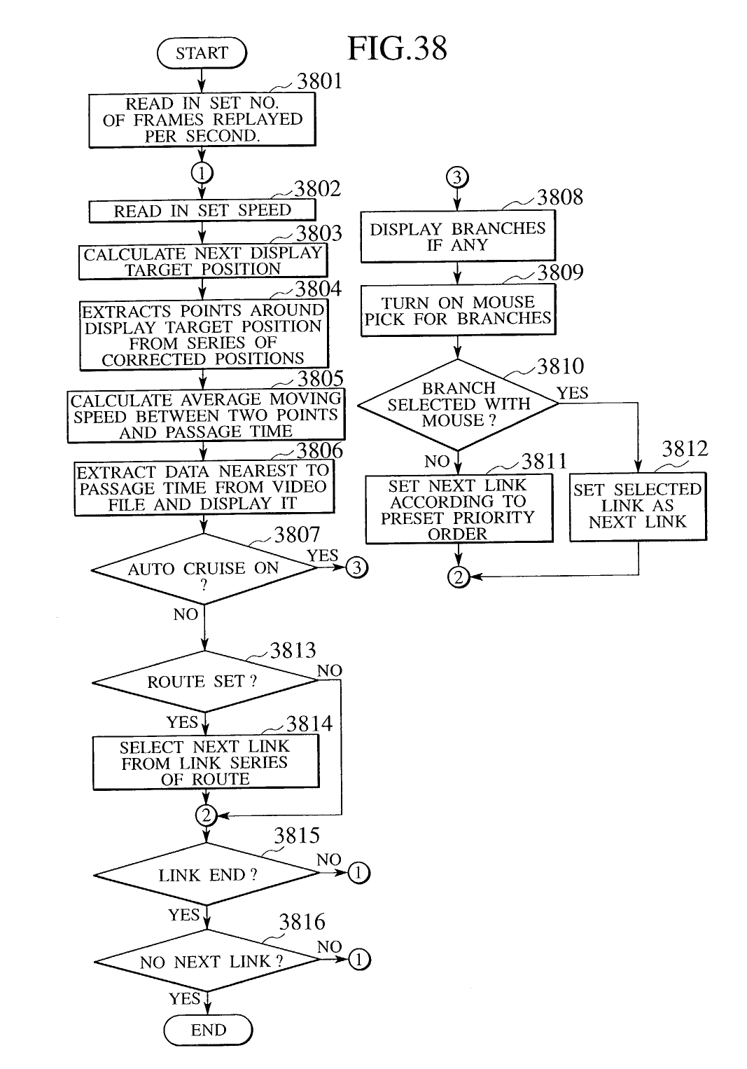

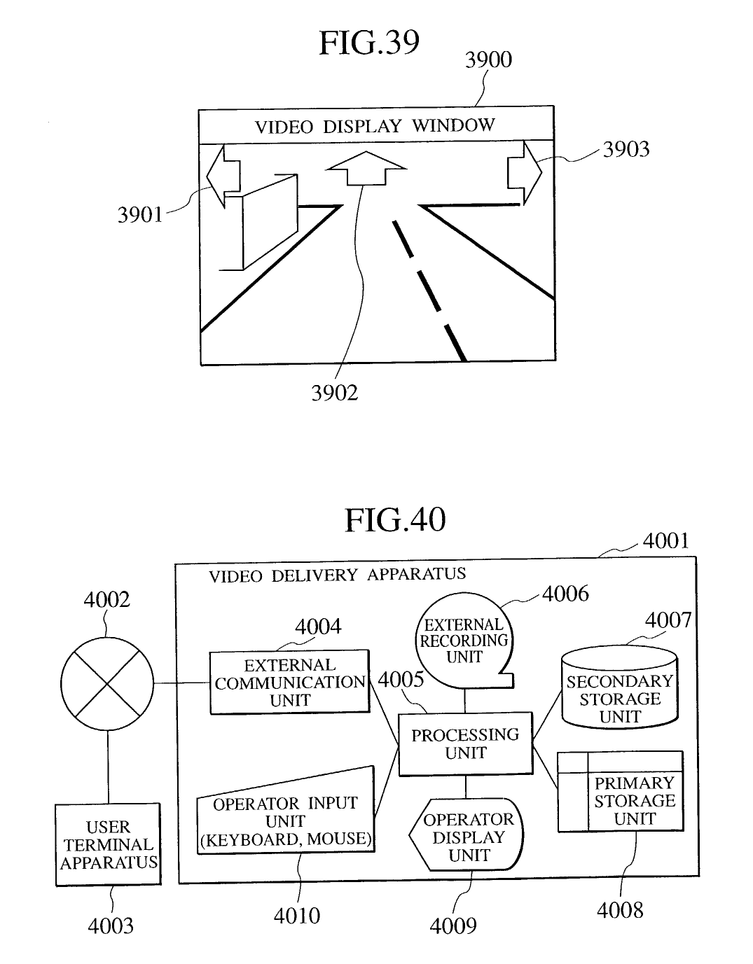

Then, the video delivery apparatus judges whether the auto-cruise mode is turned on (3807) and, if on, moves to \mathring{3}. In this case, if the end of a link is a turning point as shown in FIG. 39, the video delivery apparatus displays the areas of the turning point in the video display window 3900 (3808) and turns on the mouse pick function to allow the user to pick a route ahead of the turning point with the mouse (3809). If the route ahead of the turning point is selected with the mouse (3810), the selected route ahead of the turning point is set as the next link (3812). If no route ahead of the turning point is selected with the mouse, the next link is set according to the preset priority order (for example, forward: priority 1, left: priority 2, right: priority 3) (3811). This priority order may also be determined in such a manner that if the route ahead of the turning point has the same road attribute such as the same road No., the route is given the highest priority and if a route has been set, a route ahead of the turning point along the route is given the highest priority.

If the auto cruise mode is not turned on, the video delivery apparatus judges whether a route is set (3813) and, if set, selects the next link from the series of links (3814). This processing is repeated until the end of the link (3815) and further repeated for the subsequent all rinks if replay is to be done along a plurality of links, for example, if a route is set (3816).

FIG. 39 is example contents of the video display window displayed when the auto cruise mode is turned on. Arrow icons 3901, 3902 and 3903 in the video display window 3900 indicate respectively that a left link, a forward link and a right link can be selected with the mouse.

In this embodiment, video streams divided and saved according to a road map are replayed based on the user's arbitrary instructions as described so far. This embodiment can also be implemented with the following system configuration.

FIG. 40 is an embodiment of a system consisting of a video delivery apparatus and a data transmission apparatus which are connected to each other via a communication network. The video delivery apparatus 4001 is constituted by adding an external communication unit 4004 to the video delivery apparatus 100 described in FIG. 1. That is, it consists of a processing unit 4005, an external recording unit 4006, a secondary storage unit 4007, a primary storage unit 4008, an operator display unit 4009, an operator input unit 4010 and an external communication unit 4004. Reference numeral 4002 represents an external communication network comprises for example, the Internet or a leased line and is connected to the video delivery apparatus 4001 via the external communication unit 4004. In addition to a wired system, the external communication network 4002 may include a radio transmission system such as a portable telephone network and a radio wave LAN.

A user terminal apparatus 4003 has almost the same hardware configuration as the video delivery apparatus 4001 except that the external recording unit is not necessary. It provides display and I/O processing through the user main window 3200 described in FIG. 32. Road map data and video files described in FIGS. 2 and 8 are delivered to the user terminal apparatus 4003 from the video delivery apparatus 4001. Processing for this delivery is provided by the video delivery apparatus 4003 through the above-mentioned operator main window and the user terminal apparatus 4003 through the above-mentioned user main window. Delivery may be done in various ways. For example, a considerable amount of data may be delivered in a file at once from the video delivery apparatus 4001 to the user terminal apparatus 4003. Alternatively, realtime data may be transmitted when requested from the user terminal apparatus 4003.

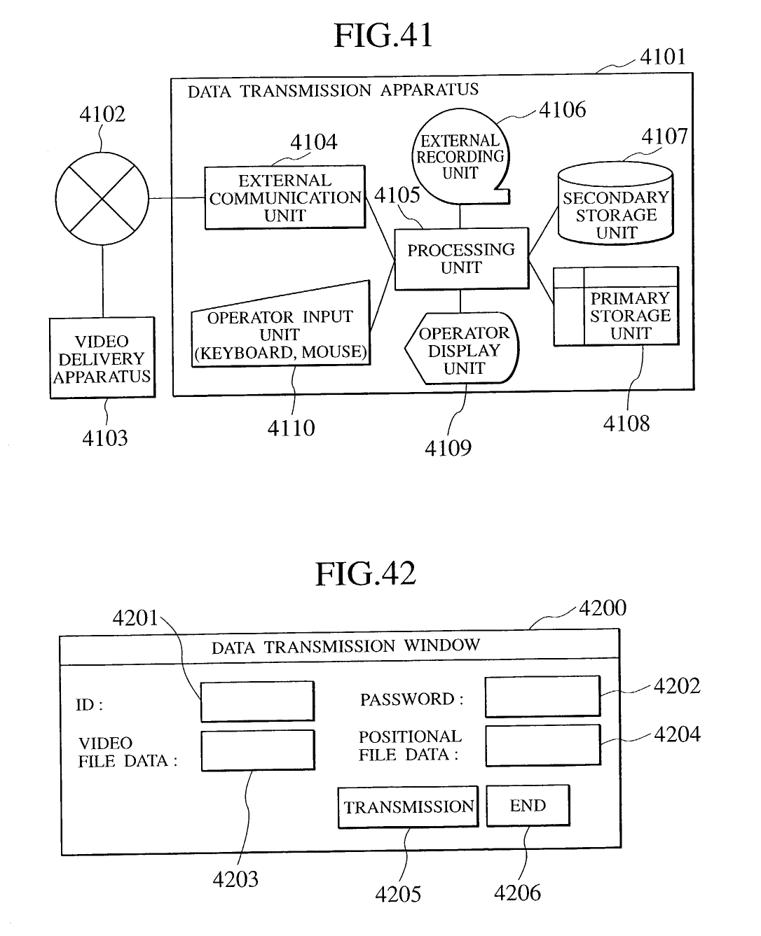

The following describes another method for storing a source video file in the video delivery apparatus 100 in FIG. 1. Although it is assumed so far that source video data are read out from the external recording section 102 in FIG. 1 and stored in the secondary storage section 103 in advance, it is also possible to store a video file transmitted from a distant place. A system configuration for this purpose is described below with reference to FIG. 41.

FIG. 41 is an example configuration of a system where a video delivery apparatus is connected with a data transmission apparatus via a communication network. The data transmission apparatus 4101 has almost the same hardware configuration as the video delivery apparatus 4001 described in FIG. 40. It has an external communication unit 4104, a processing unit 4105, an external recording unit 4106, a secondary storage unit 4107, a primary storage unit 4108, an operator display unit 4109, an operator input unit 4110. A source video file is read out from the external recording apparatus 4106 into the secondary storage unit 4107 and, from the external communication unit 4104, transmitted to a video delivery apparatus 4103 via an external communication network 4102. At this time, the video delivery apparatus 4103 executes processing to receive the source video file transmitted from the external and store it in the secondary storage unit. If all source video data are supplied from the data delivery apparatus 4101, the video delivery apparatus 4103 don't need to have an external recording unit.

FIG. 42 is example contents of a data transmission widow displayed on the operator display unit 4109 of FIG. 41. The data transmission window 4200 has a transmitter ID input box 4201, a password input box 4202, a video file data input box 4203, a positional file data input box 4204, a transmission button 4205 and an end button 4206. For management and security, the transmitter is required to enter his ID and password. The transmitter information is stored and managed in association with video information files and positional information files described in FIG. 9 and FIG. 11.

Processing flows as follows. First, if the data transmitter starts/opens the data transmission window 4200, a communication link is established with the video delivery apparatus 4103 via the communication network 4102 for file transfer. Then, if the transmitter enters information into the ID box 4201 through the positional file data box 4204, data stored in the secondary storage section 4107 are transmitted. Upon completion of the transmission, a message is displayed to indicate the completion. Finally the transmitter selects the end button to disconnect the communication link established for file transfer and terminate/close the data transmission window 4200. The data transmission window can also be implemented in the device configuration described in FIG. 1 although only file storage can be done.

Embodiments where source video is transmitted via a communication network have been described above. If different persons are in charge of transmitting data and editing source video respectively, operational efficiency may be improved by configuring the apparatus in such a manner that upon completion of video storage in the secondary storage section, the pertinent message is indicated in the operator window or E-mailed to the remote operator. Further, if the apparatus is designed in such a manner that the positional correction processing and the video division processing described in FIG. 26 and FIG. 28 are automatically executed on the stored data without the operator's intervention, the operator has only to check sectional files and register them.

The system may also be configured in such a manner that the operator main window, the road map display window and the video display window, described respectively in FIGS. 13, 14 and 15, are displayed on the operator display unit 4109 of the data transmission apparatus 4101 in FIG. 41 for the operator in charge of editing source video data, each operation made to these windows is transferred to the data transmission apparatus 4103 via the communication network 4102, the transferred operation is interpreted and executed there and the result is sent back to the video delivery apparatus. In this system, instructions to transmit and edit source video can be issued to the data transmission apparatus from a distant place.

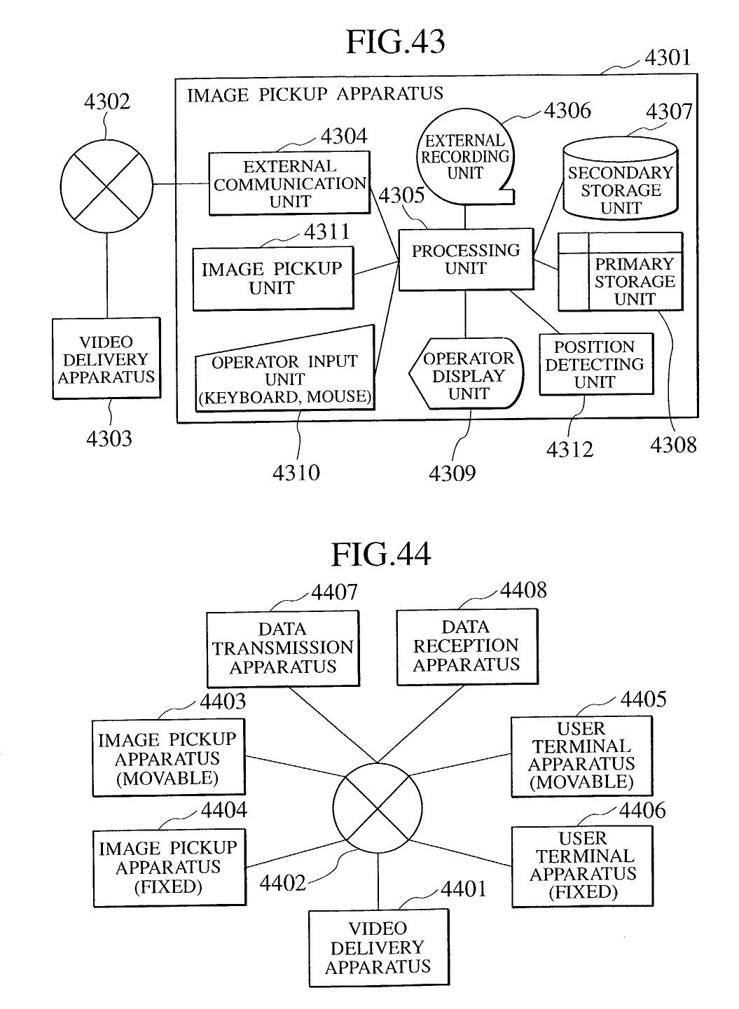

Embodiments where source video files to be stored are transferred from a remote place have been described above. With reference to FIG. 43, the following describes an example system configuration where realtime live video is received and stored instead of pre-recorded video files.

FIG. 43 is an example configuration of a system where a video delivery apparatus is connected with an image pickup apparatus via a communication network. The image pickup apparatus 4301 includes an external communication unit 4304, a processing unit 4305, an external recording unit 4306, a secondary storage unit 4307, a primary storage unit 4308, an operator display unit 4309, an operator input unit 4310, an image pickup unit 4311 such as a camera and a position detecting unit 4312 such as a GPS receiver. Reference numeral 4302 represents an external communication network. The image pickup apparatus 4301 is connected to a video delivery apparatus 4303 via the external communication section 4304.

The image pickup apparatus 4301 may be fixed onto either a fixed station or a movable station such as a vehicle. Some of the sections shown in the figure may be omitted depending on the implementation. In addition, the communication network 4302 includes a radio transmission system.

Processing flows as follows. Image picked up by the image pickup unit 4311 is converted into a format suited for the communication network by the processing unit 4305 and the primary storage unit 4308 and transmitted to the video delivery apparatus 4304 from the external communication unit 4304 together with positional information detected by the position detecting unit 4312. If the image pickup apparatus 4301 is mounted on a movable station, the video delivery apparatus 4303 stores the received data in the same manner as FIGS. 9 and 11. On the other hand, if the image pickup apparatus 4301 is mounted in a fixed station, the video data are stored as special data in association with its on-map position and the direction of shooting.

Described above is a configuration where two apparatuses are connected to each other via a communication network. With reference to FIG. 44, the following describes an example configuration of a video information delivery system consisting of more apparatuses which are all connected to one another.

FIG. 44 is an example configuration of a system consisting of video delivery apparatuses, a data transmission apparatus, a data reception apparatus, image pickup apparatuses and user terminal apparatuses which are connected with each other via a communication network. To a communication network 4402, a video delivery apparatus 4401, a movable video image pickup apparatus 4403, a stationary image pickup apparatus 4404, a data transmission apparatus 4407, a data reception apparatus 4408, a movable user terminal apparatus 4405 and a stationary user terminal apparatus 4406 are connected. Incidentally, the above apparatuses other than the video delivery apparatus 4401 may arbitrarily be combined with one another.

Each apparatus is not limited in number. In particular, the video delivery apparatus 4401 is set up in each area determined by the amount of data. When the user moves from an area covered by some video delivery apparatus to an adjacent area covered by another video delivery apparatus, continuous supply of information is secured for the user's information access through data file exchange between the video delivery apparatuses. The movable video image pickup apparatus 4403 and the stationary image pickup apparatus 4404 are identical in function to the image pickup apparatus described in FIG. 43 and the data transmission apparatus 4407 is also identical in function to the data transmission apparatus described in FIG. 41. The data reception apparatus 4408 is an apparatus for receiving data from the video delivery apparatus 4401 and making use of the data for a separate purpose. Files are transmitted to the data reception apparatus 4408 from the video delivery apparatus 4401 periodically or as requested. The movable user terminal apparatus 4405 and the stationary user terminal apparatus 4406 are identical in function to the user terminal apparatus described in FIG. 40. The apparatuses 4403, 4404 and 4407 transmit data to the video delivery apparatus 4401 and the apparatuses 4405, 4406 and 4408 receives data from the data delivery apparatus 4401.

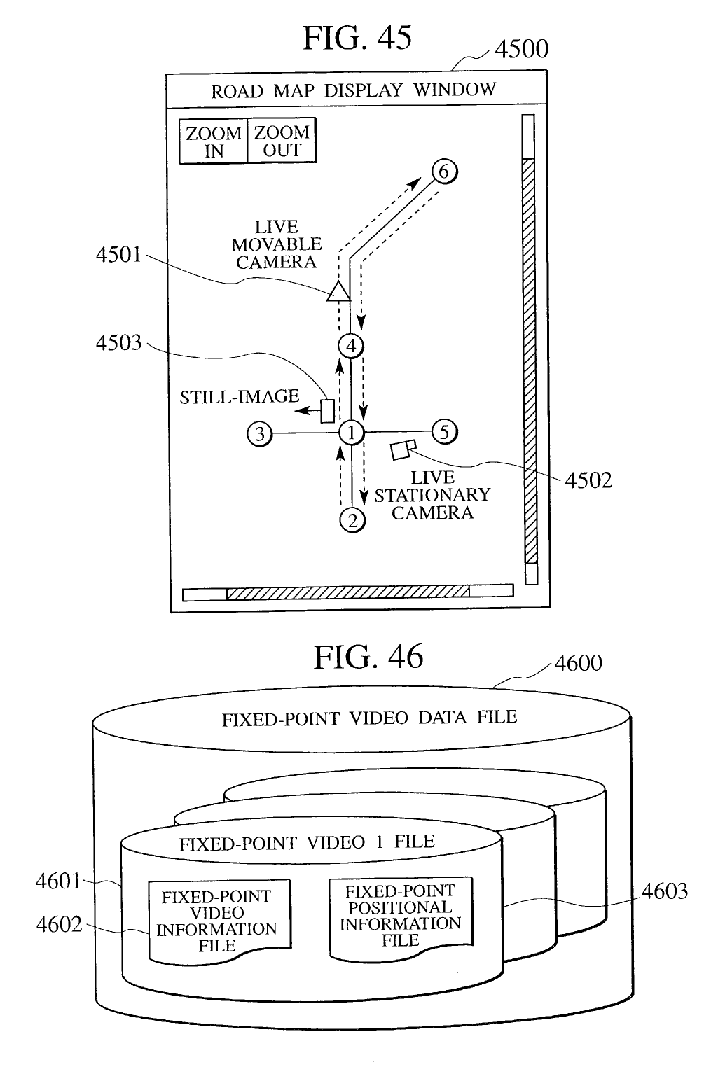

A video information delivery system where live camera images can also be treated is described above as to the general configuration with reference to FIG. 44. The following describes how and what information is provided to the user terminal apparatus 4406 in this system. FIG. 45 shows example contents of the road map display window. On a road map, the locations of a still-image camera, a live stationary camera and a live movable camera are superimposed. In the road map display window 4500, an icon 4501 indicates the position of the live movable camera and moves on the map consistently with the camera. An icon 4502 indicates the position of the live stationary camera while an icon 4503 the position of the still-image camera. If any of these icons is selected with a mouse, the corresponding motion image or still image is displayed in the video display window described in FIG. 39.

FIG. 46 is an example data file configuration for fixed-point images such as motion images recorded by stationary live cameras and still images captured by digital still-image cameras. A fixed-point video data file 4600 consists of a plurality of fixed-point video file groups. One file group 4601 consists of a fixed-point video information file 4602 and a fixed-point positional information file 4603. In the case of the stationary live camera, the amount of data in that fixed-point video file increases with the pickup duration.

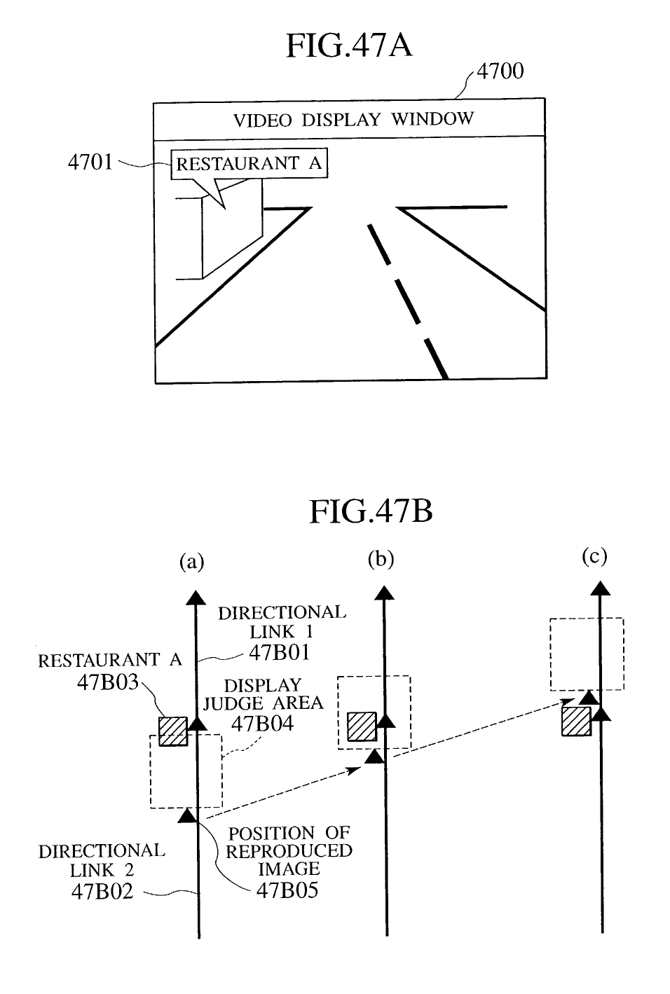

Then, the following describes an example implementation of providing roadside facilities information by using the road attribute information file described in FIG. 7. FIG. 47 shows example contents of the video display window in the display of the user terminal apparatus 4406 in FIG. 44. Road attribute information is superimposed in the video display window in FIG. 47A. The names of roadside facilities, “Restaurant A” in this example, are displayed as an icon 4701 according to their associated link Nos. and x and y coordinates shown in FIG. 7.

FIG. 47B explains how an icon is displayed in the video display window 4700. In FIGS. 47A to 47C, two arrows 47B01 and 47B02 schematically represent two successive directional links on the road. The location of the roadside facility restaurant A is indicated by 47B03. The position of the current image reproduced is marked by an triangular icon 47B05. FIGS. 47A to 47C indicate that the position of the reproduced image is moving forward.

Whether to display the icon 47B03 “Restaurant A” in the video display window is judged according to whether the facility (restaurant A) is in a display judge area 47B04 determined in advance. If the facility is in the area as FIGS. 47A and 47B, the icon is superimposed on the video. For FIG. 47C, the icon is not displayed since the facility is not in the area. In addition, the icon is dynamically shifted in the window so as to follow the facility whose position in the window depends on the position of the moving image pickup camera. The position of the facility in the window can be obtained through projection conversion technique, that is, by converting the actual coordinate system to the image pickup camera's coordinate system.

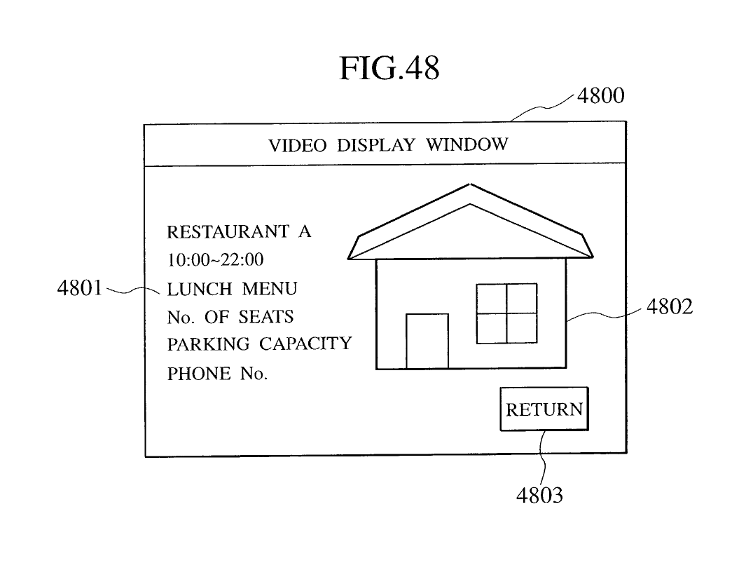

FIG. 48 shows example contents of the video display window where detailed road attribute information is displayed. If the user selects the icon 4701 in FIG. 47 with the mouse, this detailed attribute information is displayed. In this example, text information 4801 and image information 4802 are displayed in the video display window 4800. Icons superimposed on the replayed video, such as that shown in FIG. 47, are erased from the window when the facilities go out of the display judge area. On the other hand, selecting an icon stops the video replay and replaces it with detailed attribute information as shown in FIG. 48. To resume replaying the video, a return button 4803 must be selected with the mouse.

The following introduces applications of the video information delivery system described so far. Described mainly is an example system configuration for providing route guidance and roadside facilities information service to drivers or navigators in vehicles.

The image pickup apparatus 4403 and the user terminal apparatus 4405 in FIG. 44 are mounted on a vehicle and the anterior live image is transferred to the video delivery apparatus 4401. Viewing the transferred image and the pre-recorded image, the operator, as a guide, provides appropriate guidance information to the vehicle. The apparatus mounted on the vehicle may also be implemented by extending a navigation system. In addition, when guidance is given to the driver, information exchange is possible by voice between the driver and the operator if a microphone and a speaker are installed on the vehicle. The following describes what are displayed for the operator serving as a guide and how processing flows.

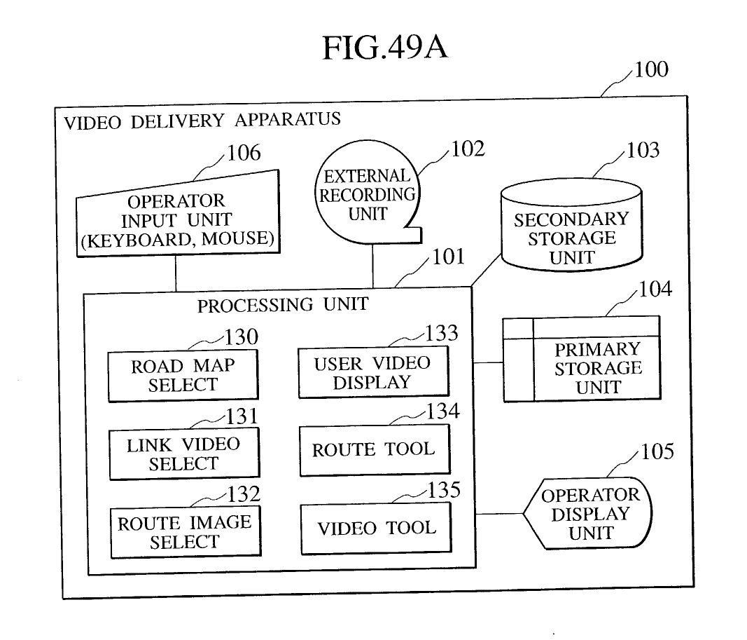

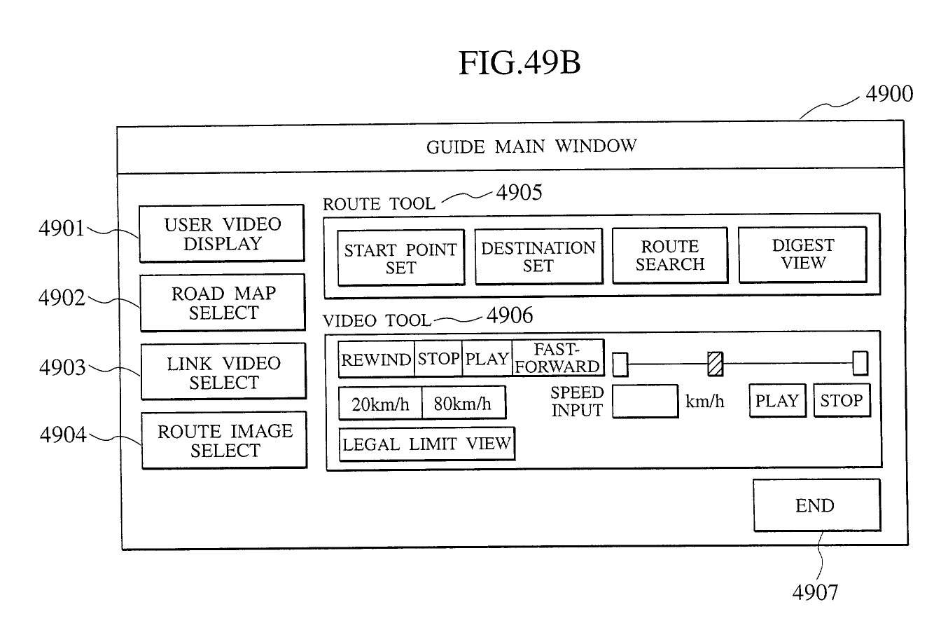

FIG. 49A shows the functions of the processing section 101. The processing section 101 in FIG. 1 is modified as shown so that the operator can serve as a guide. This processing section 101 consists of road map select means 130, link video select means 131, route image select means 132, user video display means 133, a route tool 134, a video tool 135, etc.

FIG. 49B is example contents of the main window displayed for the guide when the video information delivery system is applied to guidance. The guide main window 4900 consists of a user video display button 4901, a road map select button 4902, a link video select button 4903, a route image select button 4904, a route tool 4905, a video tool 4906 and an end button 4907. Some of these buttons are associated with the functions 130 through 135 in FIG. 49A. The route tool 4905 and the video tool 4906 are functionally identical to the route tool 3207 and the video tool 3212, respectively, described in FIG. 32.

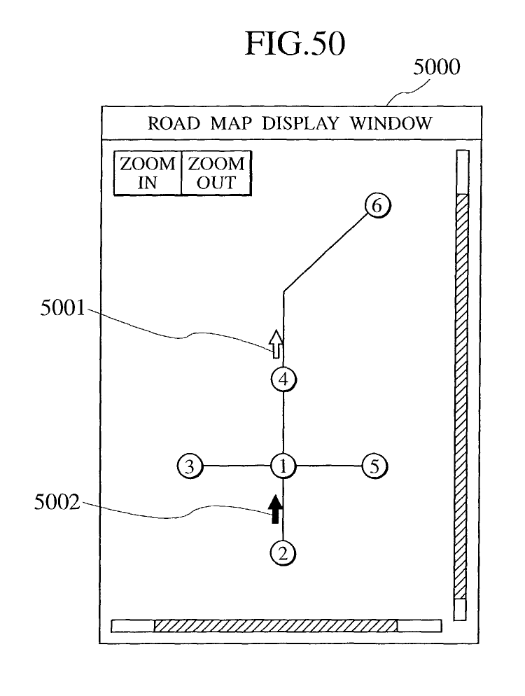

FIG. 50 is example contents of the road map display window displayed for the guide when the video information delivery system is applied to guidance. While an icon 5001 in the road map display window 5000 indicates the video replay position selected by the guide, an icon 5002 indicates the position of the video sent from the user who is receiving the guidance service. These icons are indicated in different forms and move consistently with the respective replay positions.

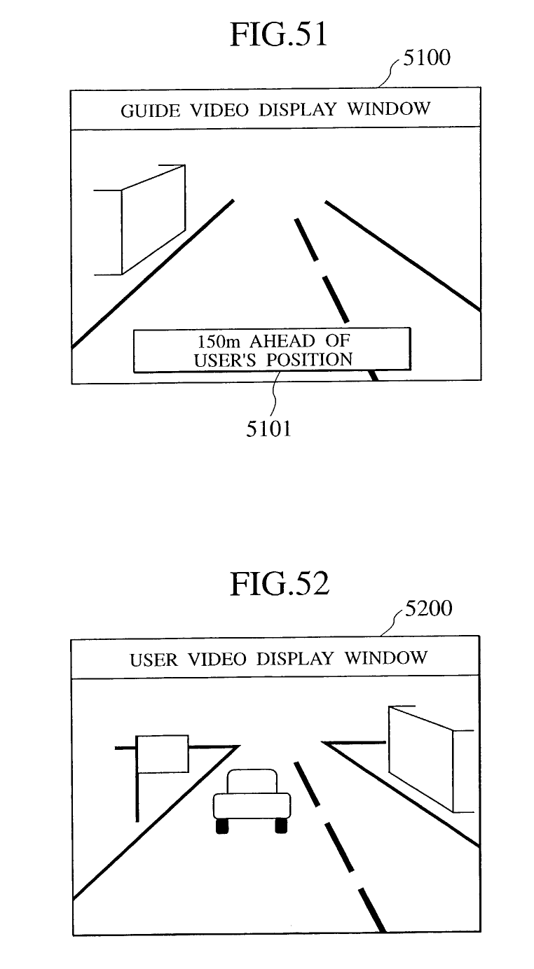

FIG. 51 is example contents of the video display window displayed for the guide when the video information delivery system is applied to guidance. The video display window 5001 is used to display the video somewhat ahead of the user position so that information necessary to guide the user can be obtained. In this example, the distance from the current image displayed to the position of the guided user is calculated and displayed in a guidance indicator 5101. By this, the guide can realize more accurate and detailed guidance.

FIG. 52 is example contents of the video display window displayed for the guide when the video information delivery system is applied to guidance service. The video display window 5200 is used to display the video sent from the guided user. By checking the video display window 5200, the guide can provide more accurate guidance to the vehicle.

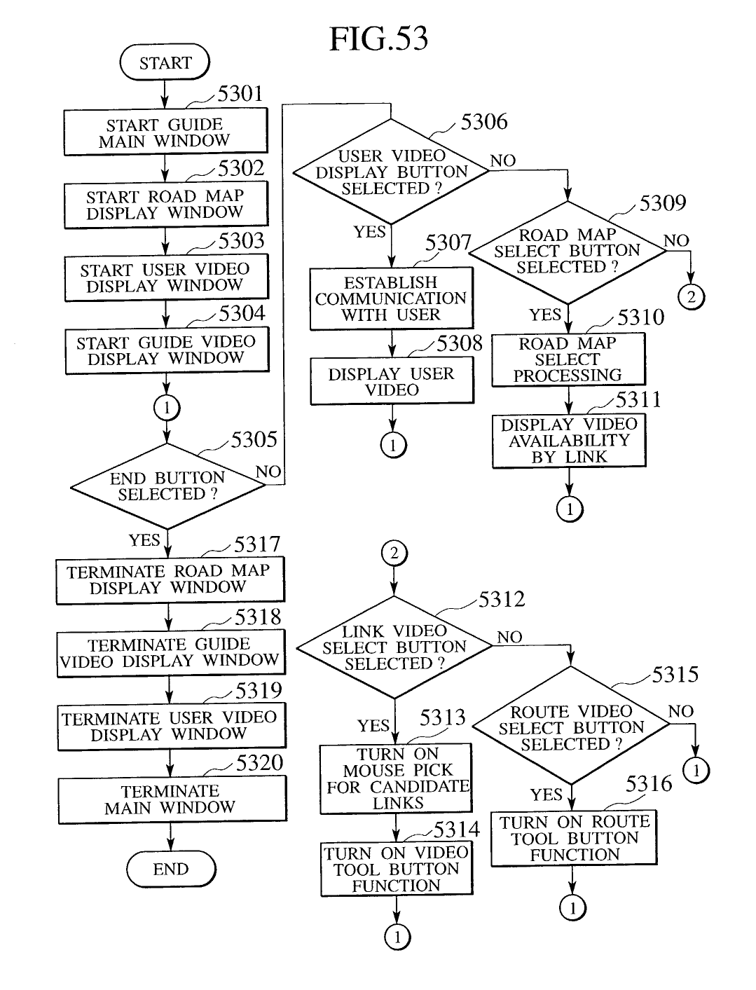

FIG. 53 is an example flowchart indicating how processing is executed in response to the guide's operations in a video information delivery system applied for guidance. First, the guide main window 4900 described in FIG. 49 is started (5301). Then, the road map display window 5000 described in FIG. 50 (5302), the user video display window 5200 described in FIG. 52 (5303) and the guide video display window 5100 described in FIG. 51 (5304) are started.

The apparatus checks the guide main window 4900 to judge whether the end button 4907 is selected in the guide main window 4900 (5305), whether the user video display button 4901 is selected (5306), whether the road map select button 4902 is selected (5309), whether link video select button 4903 is selected (5312) and whether the route image select button 4904 is selected (5315).

If the end button 4907 is found selected, the apparatus terminates/closes the road map display window (5317), the guide video display window (5318), the user video display window (5319) and finally the guide main window (5320) to terminate the whole processing on the guide main window.

If the user video display button 4901 is found selected, the apparatus establishes a communication link with the user (5307). Then, if a route is already set in the on-vehicle apparatus, the route information is received and the video from the user is displayed (5308). If a road map is selected at this time, icons are displayed in the road map display window. If the road map select button 4902 is found selected, a road map is selected similar to steps 3309 and 3310 described in FIG. 33 (5310, 5311). If a communication link is already established with the user at this time, the positional information is displayed on the road map.

If the link video select button 4903 is found selected, the apparatus turns on the mouse pick function to make it possible to select a link from candidate ones and turns on the function of each button of the video tool 4905 (3313). Then the apparatus displays icons in the road map display window. Also if the route image select button 4904 is found selected, the apparatus turns on the function of each button of the route tool 4906 (3315). Finally in either case, the apparatus gets ready to judge the user's next selection.

This guidance service can be implemented by the above-mentioned system even when only positional information is sent from the vehicle without video.

Finally, the following describes an example business style for providing service by using the video information delivery system described so far.

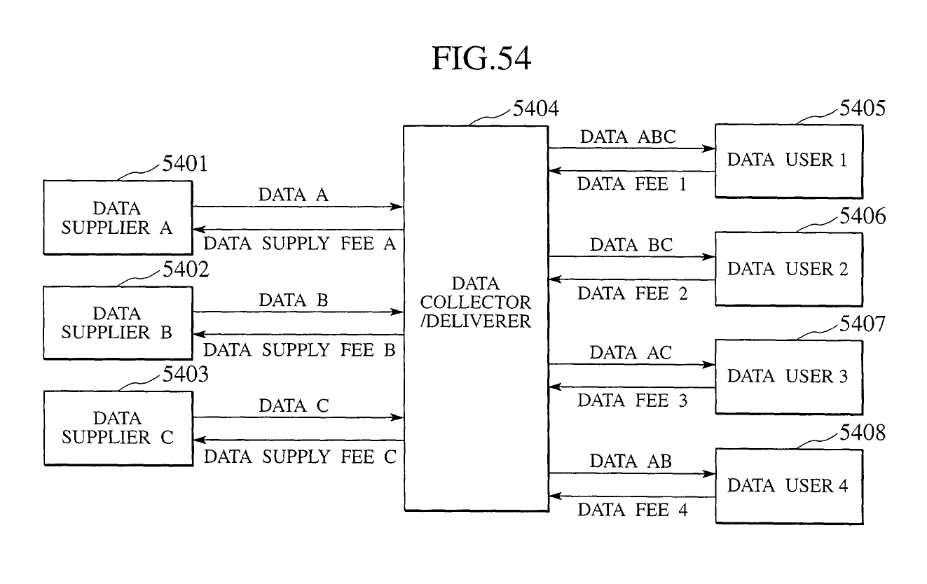

FIG. 54 shows an example scheme for mutual exchange of information and fees among three groups; data suppliers, a video information collector/deliverer and data users. Reference numerals 5401, 5402 and 5403 represent a plurality of data suppliers who supply video data and receive fees for the data. On the other hand, 5405, 5406, 5407 and 5408 represent a plurality of data users who use video data and other information and paid fees for them. A collector/deliverer 5404, standing between the two groups, receives video information from data suppliers and collects video information by itself and add road maps and roadside information to them as added value before delivered to data users. The data fees gathered from data users are sorted by data supplier and each data supplier is paid according to the total fee paid by the data users for the supplier's data. In this system, a data supplier is paid more if it provides higher value data to the data users.

Although the present invention is to implement the delivery of video information selected from the viewpoint of drivers in a road network as described so far, it can also be applied to the collection and delivery of video information for walkers on streets or inside buildings since any spaces where people can walk either within buildings or along pavements can also be represented as a network like a road network for vehicles.

The present invention can provide a video delivery apparatus capable of flexibly associating recorded video information with roadmaps. In addition, the present invention can provide a video delivery apparatus capable of replaying video consistent with a specified moving speed, not depending on the condition under which the video is recorded. Further, the present invention makes it possible to provide guidance service by using easy to understand image information, including roadside text information, when demanded by the user.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A video delivery apparatus having roadmap data stored therein, comprising video edit means which takes in video information recorded along roads and positional information measured concurrently with the video information, compares a position in the roadmap data with a measured position, and associates a piece of the video information with a corresponding position in the roadmap data.

2. A video delivery apparatus having roadmap data stored therein, comprising video edit means which takes in video information recorded with image pickup duration information along roads and positional information and time information measured concurrently with the video information, compares positions in the roadmap data with the measured positions, compares image pickup duration information with time at which the associated position have measured, and associates pieces of the video information, defined by the associated respective periods of image pickup duration, with the corresponding positions in the roadmap data.

3. A video delivery apparatus according to claim 1 wherein the positions in the roadmap data are sorted by specific points and the video information is divided according to the specific points.

4. A video delivery apparatus according to claim 3 wherein a selectable area selected on a roadmap is displayed so as to divide the video information.

5. A video delivery apparatus wherein video information prerecorded in association with positions in roadmap data is replayed, said video delivery apparatus comprising a video processing means which takes in a specified route in the roadmap data and a specified moving speed, determines a position on the route based on the moving speed, and replays the video information corresponding to the position on the route.

6. A video delivery apparatus according to claim 5 wherein the video information has image pickup time information and the time information is used to reference sectional video data into which the video information is divided and extract the video data to be replayed for display.

7. A video delivery apparatus according to claim 5 wherein the video information recorded along roads is divided into sectional video data by each road connecting turning points and sectional video data is replayed when specified.

8. A video delivery apparatus according to claim 5 wherein, when the position at which the video information is to be replayed satisfies specific conditions, the replay speed associated with the replay-position is changed with respect to the moving speed.

9. A video delivery apparatus according to claim 8 wherein when video information recorded in front of a turning point is replayed, the next route can be specified or determined according to a pre-specified priority order and subsequently the video information for the specified road is replayed.

10. A video delivery apparatus according to claim 5 wherein the stored roadmap data include roadside facilities information and, when video information recorded along roads is replayed, the roadside facilities information is superimposed on the video information.

11. A video information delivery system comprising a video information reception apparatus connected with one of the video delivery apparatuses claimed in any one of claims 1 through 4 via a communication network, wherein
the video delivery apparatus comprises a communication apparatus which transmits video information when requested from the external; and
the video information reception apparatus transmits a request to the video delivery apparatus for desired video information and comprises a display unit to replay received video information.

12. A video information delivery system comprising the video delivery apparatuses claimed in any one of claims 1 through 10, wherein said video information delivery system is connected to a video recorder to record video information along roads via a communication network and receives the video information from the video recorder.

13. A video information delivery system comprising:
a video delivery apparatus which has roadmap data and video information stored therein, receives video data transmitted from the external to take the video data into the video information and transmits the video information;
a video recorder which records video along roads and transmits video data to the video delivery apparatus; and
a user terminal apparatus for using the video information;
wherein the video delivery apparatus, the video recorder, and the user terminal apparatus are connected to one another via a communication network

14. A video information delivery system according to claim 13 wherein the video delivery apparatus or the user terminal apparatus displays the video along a specific road of the roadmap data, and at least one of the video from a fixed-point camera and the video from a moving camera differentially from the video along the specific road of the roadmap data.

15. A video information delivery method wherein, when video information recorded along a road is replayed with roadmap data including roadside information, the roadside information is superimposed on the video information and, if a roadside information item is selected, its related information is displayed.

16. A video information delivery method wherein video information obtained by a video recorder mounted on a moving body and positional information detected there are transmitted to a video delivery apparatus having roadmap data and video data stored therein and the video delivery apparatus adds pertinent positional guidance information to the video information and sends back them to the moving body.

17. A video information delivery system comprising:
a plurality of image pickup apparatuses to obtain video information and positional information at the time of obtaining the video information;
a video delivery apparatus to gather information from the image pickup apparatus and deliver the video information and the positional information to users; and
a plurality of user terminal apparatuses to receive and display the video information from the video delivery apparatus;
wherein, the plurality of image pickup apparatuses, the video delivery apparatus, and the plurality of user terminal apparatuses are connected to one another via a communication network; and
the video delivery apparatus totals the fees gathered from the plurality of user terminal apparatuses on information basis provided by said image pickup apparatus basis and determines the amount of money to be paid to each video information supplier according to the total fee gathered for the video information supplied from the image pickup apparatus.
